(19) United States
(12) Patent Application Publication
(10) Pub. No.: US 2010/0257438 A1
(43) Pub. Date: Oct. 7, 2010

(54) USER INTERFACE METHOD AND APPARATUS TO DISPLAY TABULAR SOURCE DATA IN A SMALL SCREEN DISPLAY AREA

(75) Inventors: Santiago BECERRA, SR., Del Mar, CA (US); Quinton Alsbury, Venice, CA (US); David Becerra, Venice, CA (US); Alex C. Schaefer, Solana Beach, CA (US); Brett Callaghan, San Diego, CA (US); Mauricio Eastmond, San Diego, CA (US); Patrick Cheng, San Diego, CA (US)

Correspondence Address: DUANE MORRIS LLP - (prev. San Francisco);IP DEPARTMENT, 30 SOUTH 17TH STREET, PHILADELPHIA, PA, 19103-4196, US

(73) Assignee: MELLMO INC., Del Mar, CA (US)

(21) Appl. No.: 12/419,888

(22) Filed: Apr. 7, 2009

(51) Int. Cl. G06F 17/00; G06F 3/048; G06F 17/30

(52) U.S. Cl. 715/204; 715/784; 715/243; 707/E17.044

(57) ABSTRACT

A method is provided to display information on a display screen of an electronic device comprising: providing metadata in computer readable storage media that provide indicia of associations between respective subject identifiers and respective subject data items from different ones of multiple categories; and producing a plurality of screen displays that portray the subject identifiers and respective associated subject data items from respective ones of the multiple categories.

### BACKGROUND OF THE INVENTION

1. Field of the Invention

The invention relates in general to computer user interfaces for electronic devices, and more particularly, to user interfaces to navigate within a large document on electronic devices with smaller displays.

2. Description of the Related Art

FIGS. 1A-1B are illustrative drawings of a spreadsheet (FIGS. 1A1-1A2) and a pivot table (FIG. 1B1-1B2) that are too large to be viewed all at once within the confines of a typical screen display. A pivot table is a spreadsheet feature allows data tables to be rearranged in many ways for different views of the same data. A graphical user interface (GUI) to a spreadsheet or pivot table application ordinarily includes vertical and horizontal scroll bars to achieve horizontal and vertical navigation through the document. Since, a spreadsheet or a pivot table may be too large to display all at once on a computer screen display, a user scrolls horizontally and vertically to navigate to portions of the document that are outside of the screen display.

While prior user interfaces to documents generally have been acceptable, there have been shortcomings with their use. For example, there has been a need for improvements to techniques to navigate larger documents that cannot be fit all at once within a display screen. This need is even greater in small screen devices such as mobile phones that have limited screen area in which to show user interface tools used to indicate a portion of a document that is of interest. Moreover, there has been a need for more flexible movement through documents such as a spreadsheet in which rows and columns delimit information. The present invention meets these needs.

### SUMMARY OF THE INVENTION

In one aspect, a method is provided to display information on a display screen of an electronic device. The method includes providing subject identifiers and providing subject data items in multiple categories in the media. Indicia are provided of respective associations between respective subject identifiers and respective subject data items from respective ones of the multiple categories. A plurality of screen displays are produced. Different screen displays include a plurality of the subject identifiers and respective associated subject data items from respective ones of the multiple categories;

In another aspect, an article of manufacture is provided that includes computer readable storage media encoded with computer readable information. The storage media may be a component of an electronic device that includes a display screen. The computer readable information includes a data structure that provides subject identifiers and multiple categories of subject data items. In some embodiments, the data structure comprises a plurality of objects. The data structure also provides indicia of respective associations between respective subject identifiers and respective subject data items from respective ones of the multiple categories. The computer readable information also includes computer program code to cause the device to produce a plurality of screen displays. Different screen displays include a plurality of the subject identifiers and respective associated subject data items from respective ones of the multiple categories.

These and other features and advantages of the invention will be apparent from the following detailed description in conjunction with the drawings.

### BRIEF DESCRIPTION OF THE DRAWINGS

FIGS. 1A-1B are illustrative drawings of a spreadsheet (FIGS. 1A1-1A2) and a pivot table (FIGS. 1B1-1B2) that are too large to be viewed all at once within the confines of a typical screen display.

FIGS. 2A-2C is an illustrative drawing of a source data object used to illustrate examples of some embodiments of the invention.

FIG. 3 is an illustrative generalized representation of a source data object that includes a plurality of columns and rows showing relationships among subject identifiers and subject data items in accordance with some embodiments of the invention.

FIG. 4 is an illustrative generalized representation of a first screen display sequence produced on a display screen of an electronic device in accordance with some embodiments of the invention.

FIG. 5 is an illustrative generalized representation of a second sequence of screen displays produced on a display screen of an electronic device in accordance with some embodiments of the invention.

FIG. 6 is an illustrative generalized representation of an example third screen display produced on a display screen of an electronic device in accordance with some embodiments of the invention.

FIGS. 7A-7B are illustrative generalized representations of screen displays representing a ‘virtual tutorial’ in accordance with some embodiments of the invention.

FIG. 8 is an illustrative drawing of a first screen display that includes a first list comprising first level subject identifiers and corresponding first level subject data items in accordance with some embodiments of the invention and also showing a corresponding portion of an illustrative source data object.

FIG. 9 is an illustrative drawing showing two different first screen displays from two different locations in a first sequence of screen displays in accordance with some embodiments of the invention and also showing a corresponding portion of an illustrative source data object.

FIG. 10 is an illustrative drawing of the first screen display shown in FIG. 8 and shown on the left in FIG. 9 the listed first subject identifiers and corresponding first subject items in two different vertical scroll positions and showing a bar chart overlay in accordance with some embodiments of the invention.

FIG. 11 is an illustrative drawing showing the first screen display of FIG. 8 on the left and showing a screen display showing a Totals screen display that provides a drill-down to combined monthly dollar amount totals for All Business Units Total in accordance with some embodiments of the invention.

FIG. 12 is an illustrative drawing showing the first screen display of FIG. 8 on the left and showing a screen display showing a listing of Year to Date Sales for each Client in accordance with some embodiments of the invention.

FIG. 13 is an illustrative drawing showing the first screen display of FIG. 8 on the left and showing a second screen display on the right that shows a drill-down to a list that comprises a set of second subject identifiers labeled with Client names that are associated with the first subject identifier labeled Public Sector Business Unit in accordance with some embodiments of the invention and also showing a corresponding portion of a source data object.

FIG. 14 is an illustrative drawing showing a third screen display in two different vertical scroll positions, on the left and on the right, that includes the second subject identifier DMV California and multiple second subject data items from different data categories within different columns of the row of the source data object that correspond to the subject identifier DMV California in accordance with some embodiments of the invention.

FIG. 15 is an illustrative drawing showing two alternative third screen display versions of the Sales History group of the DMV California card view.

FIG. 16 is an illustrative drawing showing a screen display transition responsive to user selection of the second subject identifier, DMV California, in the second screen display labeled, Public Sector Year to Date Sales, and showing screen transitions responsive to user selections between the third screen display, labeled DMV California and the third screen display labeled DMV Florida in accordance with some embodiments of the invention.

FIGS. 17A-17B are illustrative drawings representing processes to produce a data structure that includes mapping data based upon source data object information and to transmit such metadata and mapping data to a user device.

FIGS. 17C-17D are illustrative diagrams representing a file produced in accordance with the processes of FIGS. 17A-17B.

FIG. 17E is an illustrative entity relational diagram representing relationships among objects show in FIGS. 17C-17D in accordance with some embodiments of the invention.

FIG. 18 is an illustrative flow diagram of a process to create metadata objects and mapping data object in accordance with some embodiments of the invention.

FIG. 19 is an illustrative drawing of a SourceReportProperties object.

FIG. 20 is an illustrative drawing of a SourceRepositoryProperties object.

FIG. 21 is an illustrative drawing of a Fields object.

FIG. 22 is an illustrative drawing of a ReportInfo object.

FIG. 23 is an illustrative drawing of a Creator object.

FIG. 24 is an illustrative drawing of a FieldFormat object.

FIG. 25 is an illustrative drawing of a FieldProperties object.

FIG. 26 is an illustrative drawing of a Parameters object.

FIG. 27 is an illustrative drawing of a ParameterValues object.

FIG. 28 is an illustrative drawing of a CatalogWidgetKeys object.

FIG. 29 is an illustrative drawing of a CatalogWidgetKeyTotalFields object.

FIG. 30 is an illustrative drawing of a CatalogWidgetGrandTotalFields object.

FIG. 31 is an illustrative drawing of a CatalogWidgetGroups object.

FIG. 32 is an illustrative drawing of a CatalogWidgetGroupFields object.

FIG. 33 is an illustrative drawing of a WidgetProperties object.

FIG. 34 is an illustrative drawing of a portion of an example mapping data object in accordance with some embodiments of the invention.

FIGS. 35-38 are illustrative drawings showing relationships between the CatalogWidgetKeys object of FIG. 28 and the mapping data object of FIG. 34 used to produce an illustrative first level screen display of a first sequence of screen displays (FIGS. 35-36) and used to produce an illustrative second level screen display of a second sequence of screen displays (FIGS. 37-38).

FIG. 39 is an illustrative drawing showing relationships among the CatalogWidgetKeys object and the CatalogWidgetGroups object and layout and organization groups within an illustrative third screen display referred to as the card in accordance with some embodiments of the invention.

FIG. 40 is an illustrative drawing showing relationships among the CatalogWidgetGroupFields object and the mapping data object and layout and organization of second subject data items within the groups of the illustrative third screen display (card) in accordance with some embodiments of the invention.

FIG. 41 is an illustrative drawing showing relationships among the CatalogWidgetKeys object, the CatalogWidgetKeyTotalFields object and the mapping data object and structure of a first screen display in accordance with some embodiments of the invention.

FIG. 42 is an illustrative drawing showing relationships among the CatalogWidgetKeys object, the CatalogWidgetKeyTotalFields object and the mapping data object and two different illustrative second screen displays in accordance with some embodiments of the invention.

FIGS. 43A-43B show illustrative flow diagrams representing a process to cause an electronic device to respond to user input to produce the screen displays described with reference to FIGS. 2-16 using the structural information provided in the data objects and metadata described with reference to FIGS. 18-41 in accordance with some embodiments of the invention.

FIG. 44 is an illustrative flow diagram representing a process of dynamic placement and sizing of bar chart bars in accordance with some embodiments of the invention.

FIG. 45 is an illustrative block level diagram of a processing device that can be programmed to implement processes in accordance with embodiments of the invention.

### DETAILED DESCRIPTION OF THE PREFERRED EMBODIMENTS

The following description is presented to enable any person skilled in the art to make and use a method and apparatus to navigate a document, in accordance with embodiments of the invention, and is provided in the context of particular applications and their requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and processes are shown in block diagram form in order not to obscure the description of the invention with unnecessary detail. Moreover, labels such as ‘first’ and ‘second’ may be used to indicate distinctions between things, but use of the label ‘second’ does not necessarily imply the existence of a ‘first’ thing, and the labeling of one thing as ‘first’ and a different thing as ‘second’ does not necessarily imply a particular ordering among those two things. Thus, the present invention is not intended to be limited to the embodiments shown, but is to be accorded the widest scope consistent with the principles and features disclosed herein.

### Overview of User Interface Screen Display Organization

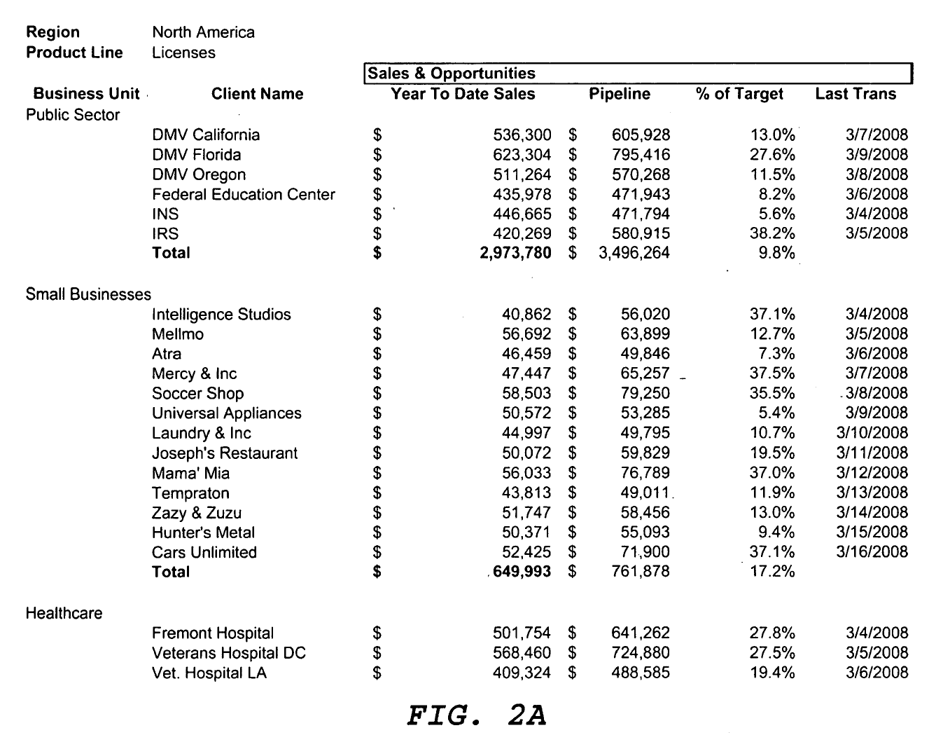

FIGS. 2A-2C are illustrative drawings of a source data table used to illustrate examples of some embodiments of the invention. The illustrative source data table can be produced using a software based enterprise reporting tool such as a tool to produce spreadsheets Crystal Reports, SAP's BEx, Oracle Reports, etc for example, which forms no part of the invention and need not be described herein. The example table is referred to as a ‘source’ data ‘object’ because it is the ‘source’ of the data to be displayed, and because, although the illustrative embodiment is illustrated through tables, the principles of the invention are applicable to a wider range data structures (i.e. objects) such as software based class structures, for example. Therefore, the terms table and object may be used interchangeably herein. It will be appreciated that information in such source object can be rearranged to present the source data or a subset of the source data differently such as through pivot table techniques, for example. It will be understood that the example source data table includes far too much information to be displayed all at once on a typical computer screen. Displaying and navigating through the source data object is especially challenging in small hand held devices that have small display screens.

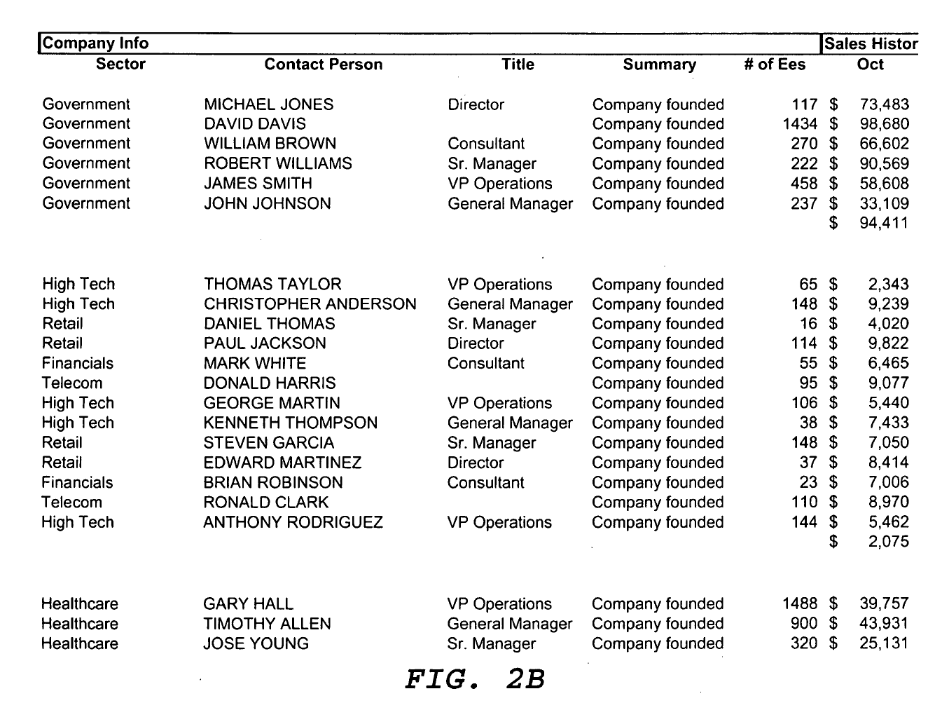

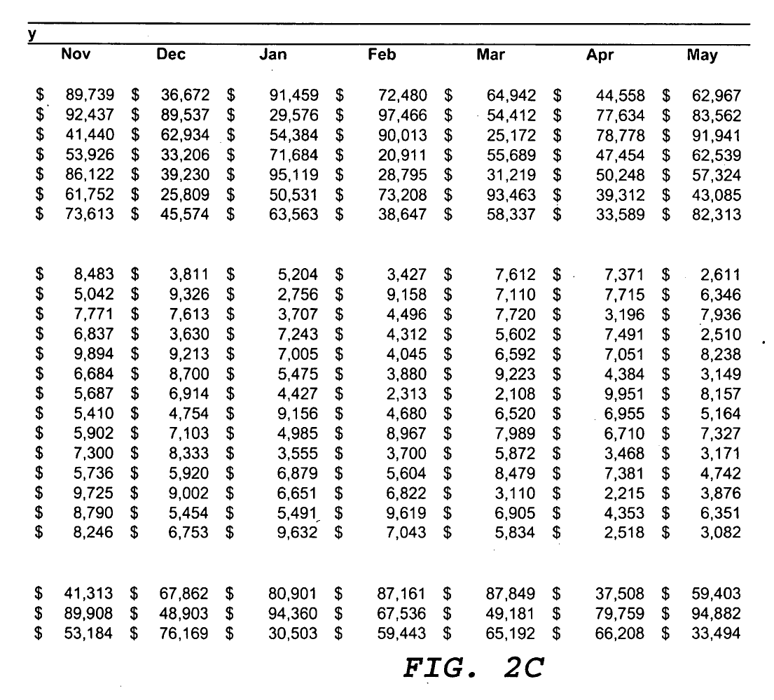

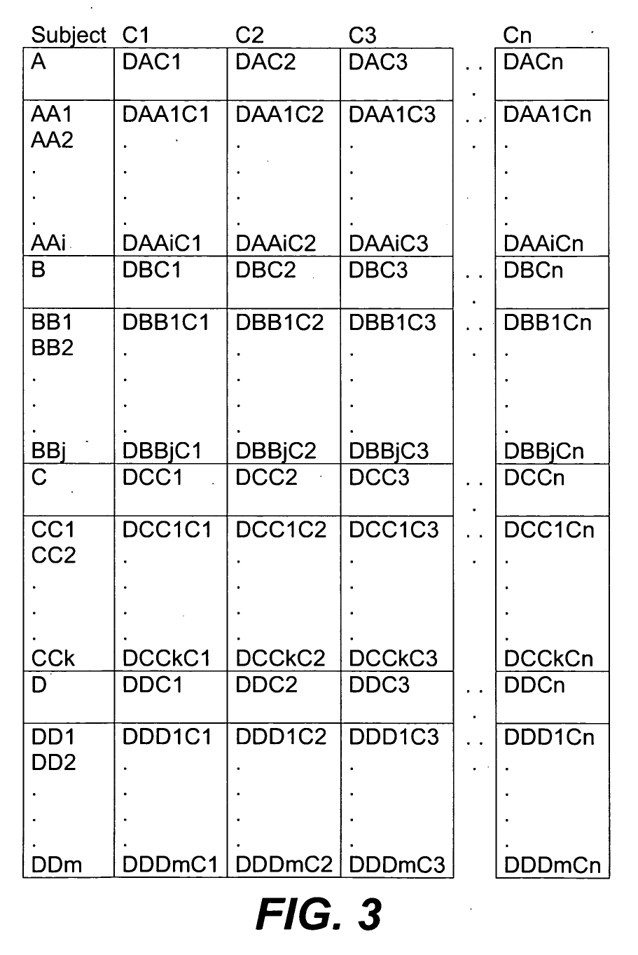

FIG. 3 is an illustrative showing a generalized representation of a source data, such as the source data table of FIGS. 2A-2C, that includes a plurality of columns and rows showing relationships among subject identifiers and subject data items in accordance with some embodiments of the invention. The example source data object in includes a first column, referred to herein as the subject identifier column, that includes a plurality of rows that contain first level subject identifiers labeled A, B, C, D, etc. Referring to FIGS. 2A-2C, for example, first level subject identifier A in the generalized source data object representation of FIG. 3 corresponds to Public Sector in the source object of FIG. 2A. First level subject identifier B corresponds to Small Business in the generalized source object representation of FIG. 2A. First level subject identifier C corresponds to Healthcare in the generalized source object representation of FIG. 2A. First level subject identifier D corresponds to Financial (not shown) in the source object of FIG. 2A. The illustrative source data object in FIG. 3 also includes a plurality of rows that contain second level subject identifiers labeled AA₁-AAᵢ, BB₁-BBⱼ, CC₁-CCₖ, and DD₁-DDₘ, etc. Referring to again to FIGS. 2A-2C, for example, second level subject identifiers AA₁-AAᵢ in the generalized source data object representation of FIG. 3 corresponds to DMV California, DMV Florida, DMV Oregon, etc. in the source object of FIG. 2A Second level subject identifiers BB₁-BBⱼ, in the generalized source data object representation of FIG. 3 correspond to Intelligence Studios, Mellmo, Atra, Mercy & Inc, Soccer Shop, etc. in the source object of FIG. 2A. Thus, for example, referring to FIG. 3, the first level subject identifier A encompasses second level subject identifiers labeled AA₁-AAᵢ. Correspondingly, for example, referring to FIGS. 2A-2C, the Public Sector Business Unit includes DMV California, DMV Florida, DMV Oregon, etc.

It will be appreciated that the source data object may include numerous first level and second level identifier levels and numerous data categories, but only a few are shown in order to avoid unnecessary complication of the description. The second level subject identifiers may comprise a sub-category of the first level subject identifiers. In further more detailed examples set forth below, the first level subject identifiers identify Business Units and the second level subject identifiers identify Clients grouped within the Business Units.

The generalized source data object representation of FIG. 3 also includes a plurality of data category columns labeled C1 to Cₙ, each containing a different category of subject data items. The source data object of FIGS. 2A-2C provides some detailed examples of possible data categories which include, Year to Date Sales (corresponding to C1 in FIG. 3), Pipeline (corresponding to C2 in FIG. 3), Per Cent of Target (corresponding to C3 in FIG. 3), Last Transaction (corresponding to C4 in FIG. 3), Sector (corresponding to C5 in FIG. 3), Contact Person (corresponding to C6 (not shown) in FIG. 3), etc. Each data category column includes a plurality of rows, each containing data pertaining to first or second level subject information sharing the same row. Thus, for example, the row that contains first level subject identifier A also includes subject data items DAC1, DAC2, . . . DACₙ from data category columns C1 to Cₙ. Referring to FIGS. 2A-2C, for example, a first level data category (DAC1) for the first level subject identifier (A) Public Sector is the Year To Date Sales Total, 2,973,780. Likewise, referring again to FIG. 3, the row that contains first level subject identifier B also includes subject data items DBC1, DBC2, . . . DBCn from data category columns C1 to Cₙ.

Similarly, the rows that contain second level subject identifier AA1 also includes subject data items DAA₁C1, DAA₁C2, . . . DAA₁Cₙ from data category columns C1 to Cₙ. Referring to FIGS. 2A-2C, for example, second level subject identifier (AA1) DMV California includes subject data items (DAA₁C1, DAA₁C2, . . . DAA₁Cₙ), specifically, Year To Date Sales (536,300), Pipeline (605,928), etc. Likewise, the rows that contain second level subject identifier BBⱼ also includes subject data items DBBⱼC1, DBBⱼC2, . . . DBBⱼCₙ from data category columns C1 to Cₙ.

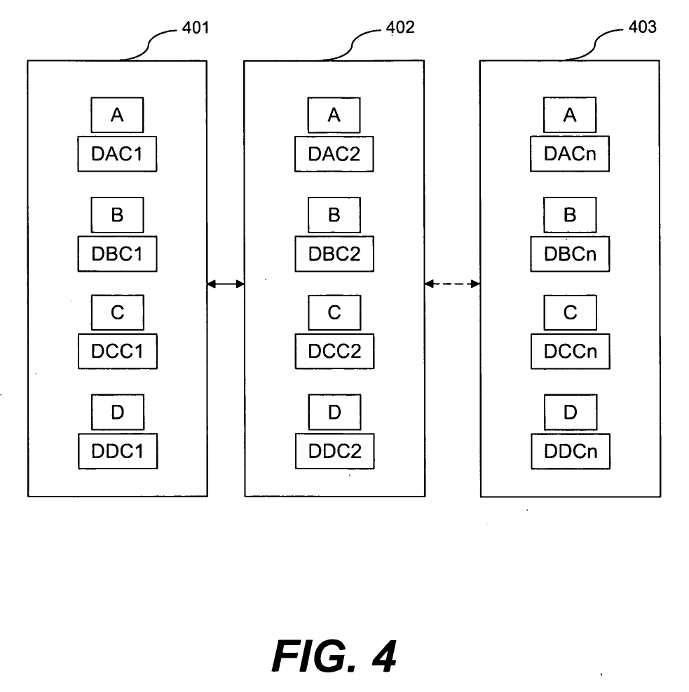

FIG. 4 is an illustrative generalized representation of a first screen display sequence produced on a display screen of an electronic device in accordance with some embodiments of the invention. Each first screen display includes a plurality of first level subject identifiers (A, B, C, D, etc.) that correspond to first level subject identifiers from the example generalized source data object representation of FIG. 3. Moreover, different first screen displays in the first sequence of screen displays include first level subject data items associated with the first level subject identifiers. The first screen display 401 in the first sequence includes a list of first level subject identifiers A, B, . . . D, and includes first level subject data items, DAC1, DBC1, . . . DDC1, from the first data category C1 of the source data object. The second screen display 402 in the first sequence includes the list of first level subject identifiers A, B, . . . , D, and includes first level subject data items, DAC2, DBC2, . . . DDC2, from the second data category C2 of the source object. The nth screen display 40n in the first sequence includes the list of first level subject identifiers A, B, . . . , D, and includes first level subject data items, DACn, DBCn, . . . DDCn, from the nth data category Cₙ of the source object.

Each of the screen displays in the first screen display sequence shown in FIG. 4 includes the same list of first level subject identifiers (A, B, C, D, etc.), but each different screen display in the first screen display sequence associates the first level subject identifiers with different first level subject data items. For instance, screen display 401 associates first level subject identifier C with first level subject data item DCC1. Screen display 402 associates first level subject identifier C with first level subject data item DCC2. Screen display 40n associates first level subject identifier C with first level subject data item DCCn. Thus, a transition from one screen display in the first screen display sequence to a different screen display in that sequence involves changing the first level subject data item but does not involve changing the first level subject identifiers. As explained below, this approach to changing screen displays is significant to some aspects of the invention since it obviates the need to change the entire screen display. Instead, the subject data item portion of the screen display changes as a transition is made between screen displays of the first sequence of screen displays. A user can view each subject data item without losing sight of the context provided by having the subject identifiers in the same view, and new data can be introduced without waiting for the page to refresh/redraw new data.

Movement between the individual first screen displays of the first sequence of screen display as shown in FIG. 4 may correspond to movement through the source object of FIGS. 2A-2C from column to column from, i.e. from one data category to the next, to show first level subject data items from different data categories associated with the first level subject identifiers, for example. Moreover, as explained more fully below, the device display screen may not be large enough to show all first level subject identifiers and all first level subject data items simultaneously, and a user may have to scroll vertically through individual first screen displays in order to view all of the information provided in such screen display.

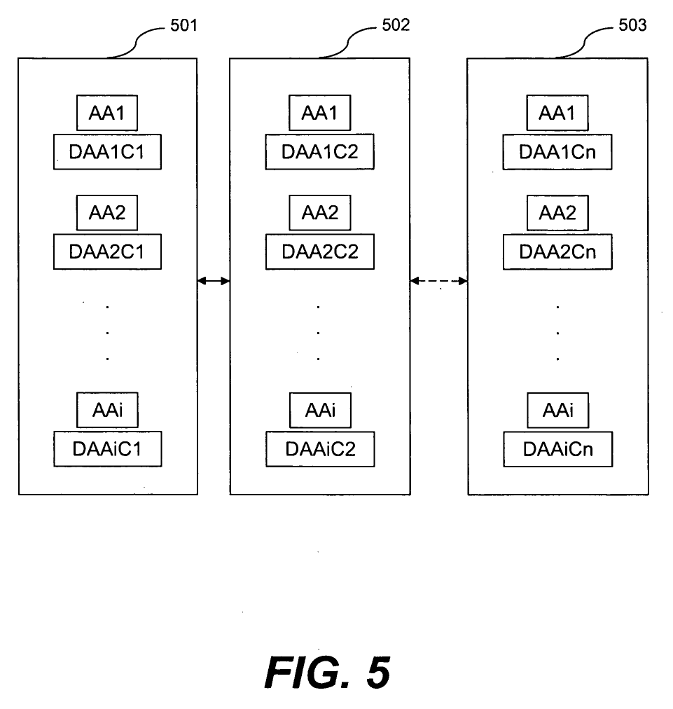

FIG. 5 is an illustrative generalized representation of a second sequence of screen displays produced on a display screen of an electronic device in accordance with some embodiments of the invention. Each second screen display includes a plurality of second level subject identifiers that correspond to second level subject data items from the generalized source object representation of the example FIG. 3. Different second screen displays in the second sequence of screen displays include different second level subject data items associated with the displayed second level subject identifiers. The first screen display 501 in the second sequence includes a first list of second level subject identifiers AA₁, AA₂, . . . , AAᵢ, and includes second level subject data items, DAA₁C1, DAA₂C1, . . . DAAᵢC1, from the first data category C1 of the generalized source object of FIG. 3. The second screen display 502 in the second sequence includes that list of second level subject identifiers AA₁, AA₂, . . . , AAᵢ, and includes second level subject data items, DAA₁C2, DAA₂C2, . . . DAAᵢC2, from the second level subject data category C2 of the generalized source object of FIG. 3. The nth screen display 50n in the second sequence includes the list of first level subject identifiers AA₁, AA₂, . . . , AAᵢ, and includes second level subject data items, DAA₁C3, DAA₂C3, . . . DAAᵢC3, from the second data category Cₙ of the source object of FIG. 3.

Each of the screen displays in the second screen display sequence shown in FIG. 5 includes the same list of second level subject identifiers (AA1, AA2, . . . AAi), but each different screen display in the second screen display sequence associates the second level subject identifiers with different second level subject data items. For instance, screen display 501 associates second level subject identifier AA2 with second level subject data item DAA2C1. Screen display 502 associates second level subject identifier AA2 with second level subject data item DAA2C2. Screen display 50n associates second level subject identifier AA2 with second level subject data item DAA2Cn. Thus, a transition from one screen display in the second screen display sequence to a different screen display in that sequence involves changing the second level subject data but does not involve changing the second level subject identifiers. This approach to changing screen displays is significant to some aspect so the invention since it obviates the need to change the entire screen display. Instead, the data portion of the screen display changes as a transition is made between screen displays of the second sequence of screen displays.

Movement between the individual second screen displays of the second sequence of screen displays corresponds to movement through the source object from column to column from one data category to the next to show second level subject data items from different data categories associated with the second level subject information. Moreover, as explained more fully below, the device display screen may not be large enough to show all second level subject identifiers and all second level subject data items simultaneously, and a user may have to scroll vertically through individual second screen displays in order to view all of the information provided in such screen display.

Each first level subject identifier in the first sequence of screens shown in FIG. 4 is associated with corresponding metadata (not shown), which is described below in detail. In response to a user input indicating selection of a given first level subject identifier, such corresponding metadata is used to direct the device to change its display screen from one of the first display screens within the first sequence shown in FIG. 4, to a second display screen within the second sequence of screen displays of FIG. 5. Metadata is used to associate each respective first level subject identifier with a respective set of second subject identifiers displayed in a respective second sequence of screen displays. For example, in further more detailed examples below, the metadata associates a first level subject identifier identifying a Financial business unit with a second level subject identifiers that identify Clients within the Financial business unit, (e.g. ADP, Aegon Insurance, AIM Trimark Investments, etc.). A user command indicating user selection of any given first level subject identifier from one of the illustrative screens of FIG. 4 causes the device to use such metadata to change its screen display to show one of the illustrative screen displays of FIG. 5.

In some embodiments, user input selecting a first level subject identifier from a given first screen display causes the device to display a second screen display that includes a list of second level subject identifiers associated with second level subject data items from the same data category level (i.e. from the same column) as that of the first level subject data items shown on the given first screen display. In other words, in some embodiments, a user input selecting a first level subject identifier from a given first screen display in a first sequence shown in FIG. 4 causes the device to use the metadata change the display to a second screen display in a second sequence shown in FIG. 5 that has the same order in the second sequence that the given first screen display from which the selection is made has in the first sequence. For example, in some embodiments, a user input of a command indicating a selection of a first level subject identifier A in the second in sequence order first screen display 402 shown in FIG. 4 causes the electronic device to display the second in sequence order screen display 502 in the second sequence of second screen displays of FIG. 5. Similarly, for example, a user input of a command indicating a selection of a first level subject identifier B in the nth in sequence order first screen display 40n shown in FIG. 4 causes the electronic device to display the nth in sequence order screen display 50n in the second sequence of second screen displays of FIG. 5. Thus, the list of first level subject identifiers in the first screen display sequence through operation of corresponding metadata, serve as an index to the second level subject identifiers of the second sequence of second screen displays.

FIG. 6 is an illustrative generalized representation of an example third screen display produced on a display screen of an electronic device in accordance with some embodiments of the invention. The example third screen display includes multiple groups of second level subject data items each from a different category (i.e. column in the illustrated embodiments) corresponding to a second level subject identifier. Metadata is used to associate each respective second level subject identifier with multiple second subject data items displayed in one or more groups in the third screen display. In particular, the example third screen display of FIG. 6 corresponds to a second level subject identifier AA₃ of FIG. 5, and the data items within the multiple groups comprise data items from categories C1 to Cₙ from the source object of FIG. 3. Each group includes one or more second level subject data items from a subset of the data categories of the source object. In particular, a first group G1 includes second level subject data items DAA₃C1-DAA₃C3 from categories C1 to C3. A second group G2 includes second level subject data items DAA₃C4-DAA₃C6 from categories C4 to C6. A third group G3 includes second level subject data items DAA₃Cn-2-DAA₃Cn from categories Cn-2 to Cn.

Thus, the example third screen display of FIG. 6 includes individual second level subject data items from the row of the generalized source object representation of FIG. 3 corresponding to the second level subject identifier associated with such third screen display. In particular, the third screen display of FIG. 6 portrays second level subject data items from the row of the generalized source object representation that contains information corresponding to the second level subject identifier AA₃. Assuming, for example, that the second level subject identifier AA₁ of the source data object of FIG. 6 corresponds to the Client Name DMV California of illustrative FIGS. 2A-2C, then second level subject data items in G1, G2 and G3 of FIG. 6 correspond to the values in the row of the source object of FIGS. 2A-2C to the right of the Client Name DMV California.

Each second level subject identifier in each second sequence of screen displays is associated with corresponding metadata. In response to a user input indicating selection of a given second level subject identifier in one of the second screen displays of FIG. 5, the device changes its display screen to show a third display screen that portrays multiple second level subject data items from a row of the source object corresponding to the selected second level subject identifier. For example, each second level subject identifier AA₁, AA₂, . . . AAₙ of the second sequence of screens shown in FIG. 5 is associated with metadata. In response to a user indicating a selection of one of the second level subject identifiers in one of the second screen displays, the device uses such metadata to change its display screen to show a third screen display that portrays multiple second level subject data items corresponding to the selected second level subject identifier. If the user inputs a command indicating selection of second level subject identifier AA1, then the display changes to a third screen display in which the data items within the multiple groups, G1, G2 and G3, are from the row of the source object corresponding to the selected second level subject identifier AA₁.

Alternatively, for example, if a currently displayed screen display is from a second sequence displaying a list of second level subject identifiers BB₁, BB₂, . . . BBn and associated second level subject data items (not shown), then a user input command indicating selection of second level subject identifier BB₂, causes the device to use the metadata to show a third screen display (not shown) portraying second level subject data items from multiple columns of the source object corresponding to the selected second level subject identifier BB₂. Accordingly, a user is able to zero in on data from a particular row of the source object by selecting a second level subject identifier shown within the multiple second screen displays of the second sequence. Therefore, the lists of second level subject identifiers in the second sequences of second screen displays through operation of corresponding metadata, serve as an index to the third screen displays. It will be appreciated that the device display screen may not be large enough to show all groups simultaneously, and a user may have to scroll vertically through individual third screen displays in order to view all of the information provided in such screen display.

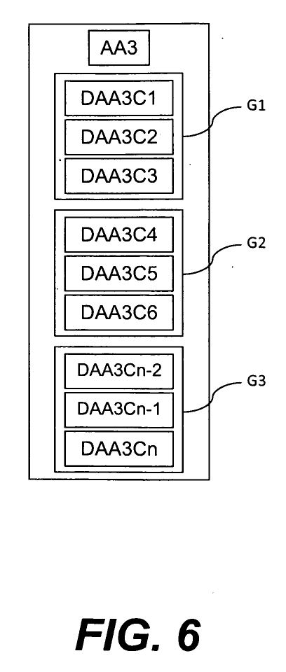

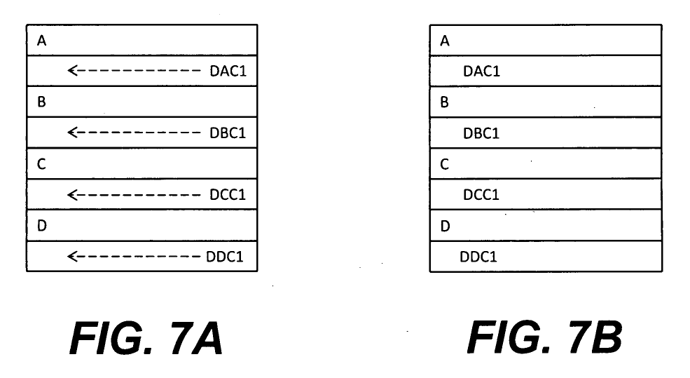

FIGS. 7A-7B are illustrative generalized representation of screen displays representing a ‘virtual tutorial’ in accordance with some embodiments of the invention. The arrows pointing right to left in the screen display of FIG. 7A signify that when a user first loads a source information for viewing, an animation effect is produced showing the first data items moving dynamically from right to left. Alternatively, the animation also may show the first subject identifiers moving dynamically from right to left. The screen display of FIG. 7B shows the first subject identifiers and the first subject data items in their final positions following the introductory animation. The animation effect at start-up alerts a user that horizontal scrolling is possible. The animation effect may provide the user with a preview of the sets of first subject data items that are available for viewing. For example, multiple sets of first subject data items (e.g., those of display screens 401, 402, . . . 40n of FIG. 4) can be moved across the screen to give the user a preview of all available sets of first subject data items. Alternatively, the animation effect can be displayed with fewer than all of the first subject data items being shown to shift across the viewing area so as to provide the user with an indication of the availability of horizontal navigation of the sets of first subject data items.

### Example Screen Displays of an Illustrative Embodiment

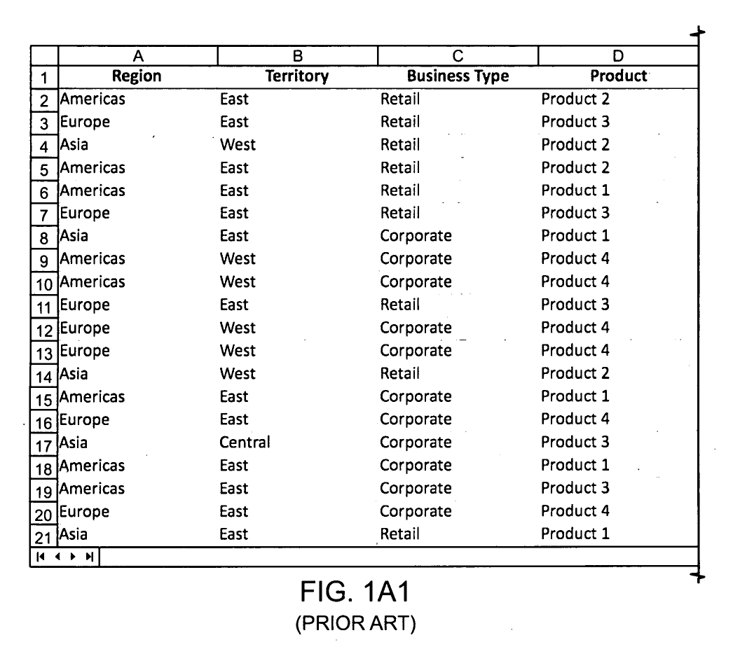

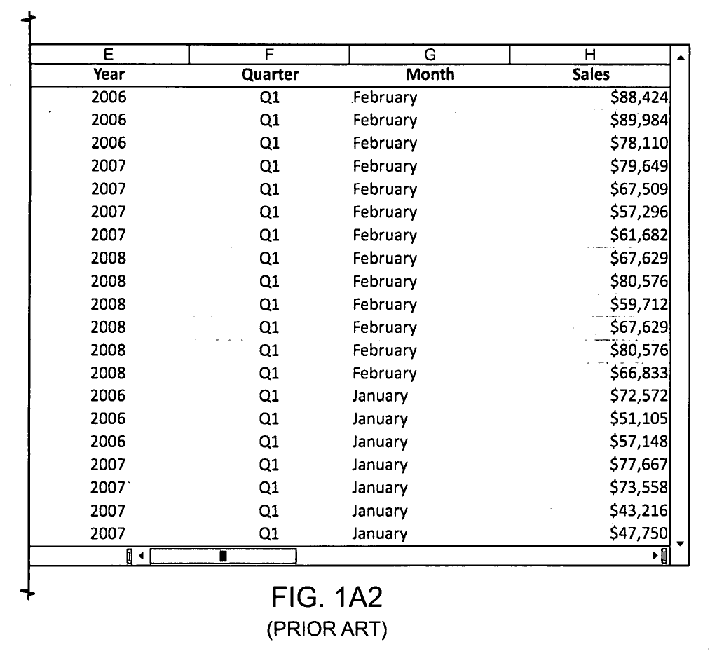

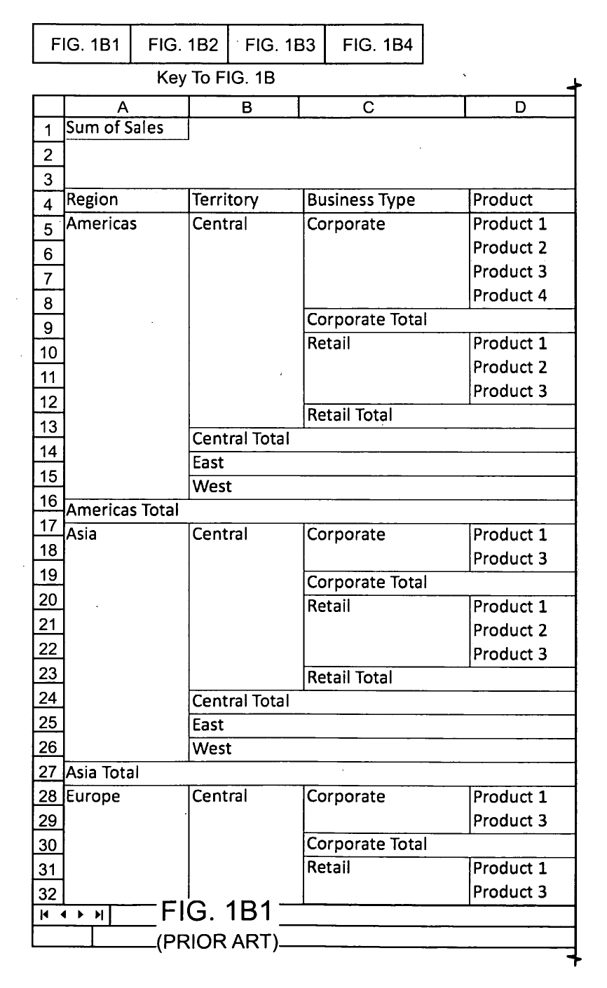

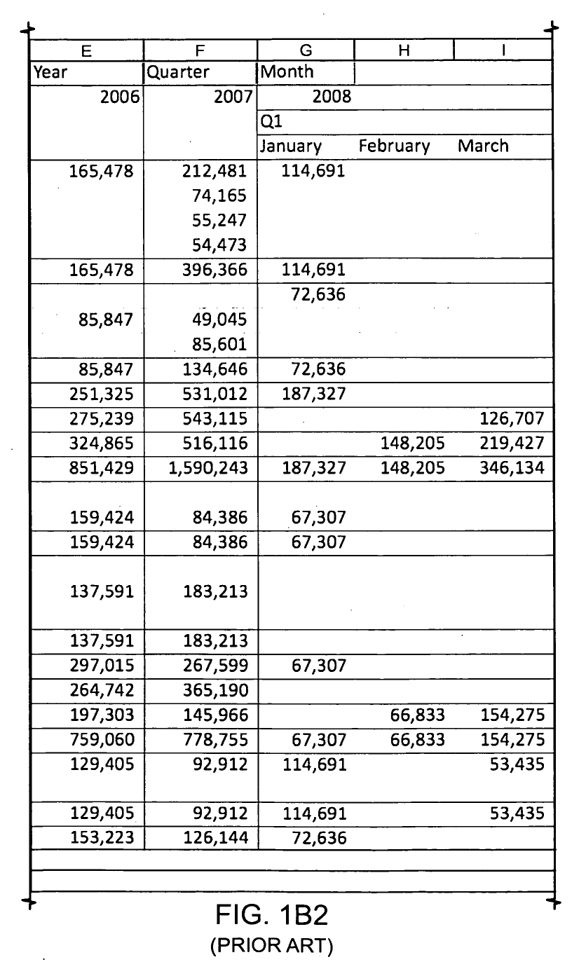

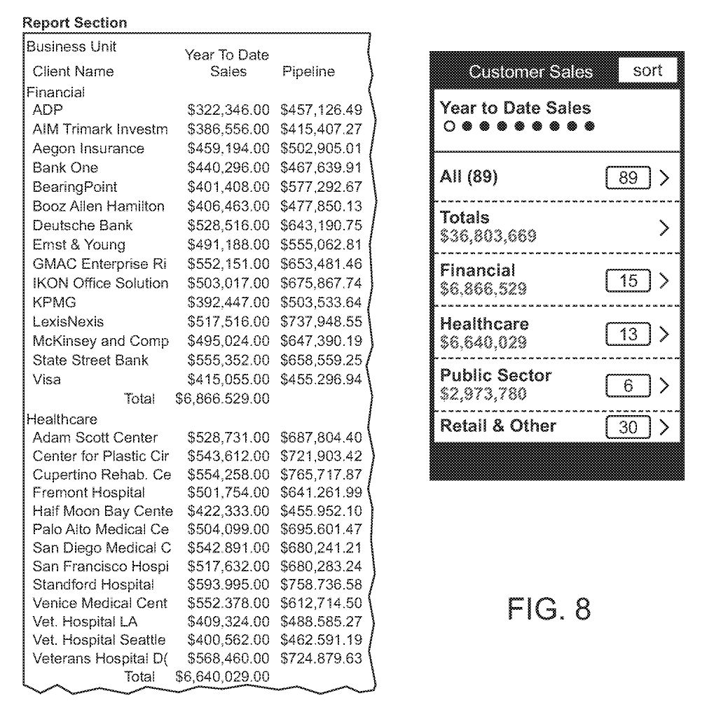

FIG. 8 is an illustrative drawing of a first screen display that includes a first list comprising first level subject identifiers and corresponding first level subject data items in accordance with some embodiments of the invention and also showing a corresponding portion of an illustrative source data object. Note that the illustrative source data object portion shown in FIG. 1 is consistent with by not identical to the object of FIGS. 2A-2C. The first screen display is one of several first screen displays in a first sequence of screen displays that can be produced on a display screen of an electronic device in response to user input. The first level subject identifiers are listed vertically in the same vertical order in which they appear in the source data object. In this example, respective first level subject identifiers correspond to respective Business Units. The Business Units include Financial, Healthcare, Public Sector and Retail & Other, Small Business and Technology. Not all of these Business Units is visible in the illustrative source object portion shown in FIGS. 2A-2C.

A label at the top of the first screen display shown in FIG. 8 indicates that the first level subject data items represent Year to Date Sales. Also near the top is an indication labeled All that indicates that there is a total of eighty-nine Clients and that the total sales for all Clients is $36,803,669. The first subject data item $6,866,529 adjacent the first subject identifier Financial indicates the total Year to Date Sales for Financial Clients. Similarly, for example, the first subject data item $2,973,780 adjacent the first subject identifier Public Sector indicates the total Year to Date Sales for Public Sector Clients. To the right of and adjacent to each first level subject identifier is an indication of the number of Clients in the Business Unit associated with that first level subject identifier. For example, the Healthcare Business Unit is shown to include thirteen Clients.

A user may input commands to scroll through the first list vertically (i.e., up or down) to observe different first level subject identifiers and their corresponding first level subject data items. In addition, a user may input commands to scroll horizontally (i.e., left or right) to change to a different first screen display in the first sequence of screen that show the same first level subject identifiers associated with different first level subject data items. The user input required to achieve vertical or horizontal scrolling depends upon device user input features of the electronic device and forms no part of the present invention. For example, a vertical or horizontal finger swipe across the display screen may result in vertical scrolling in some devices, and appropriate rotation of a track ball may achieve vertical or horizontal scrolling in other devices, for example. Moreover, a user may input commands to select a first level subject identifier so as to drill down to lower level second level subject identifiers as explained more fully below. Again, the user input required depends upon device user input features.

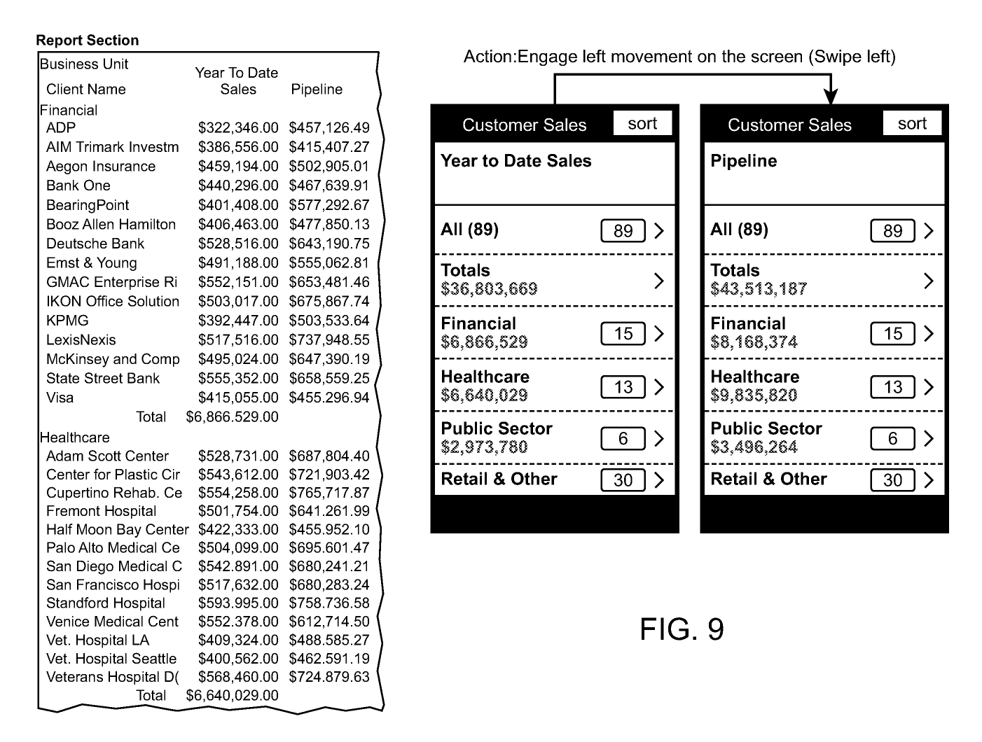

FIG. 9 is an illustrative drawing showing two different first screen displays from two different locations in a first sequence of screen displays in accordance with some embodiments of the invention and also showing the corresponding portion of the illustrative source data object shown in FIG. 2A-2C. Different first screen displays in the first sequence portray different types of first subject data items. The first screen displays have an order within the first sequence that corresponds to order within the source data object of the types of data that the different first screen displays show. It will be appreciated that only one of the two screen displays at a time appears on the device display screen. A user may input commands to cause the device to horizontally scroll first subject data items in a manner similar to that described with reference to FIG. 4 so as to transition between the first screen display shown on the left and first screen display shown on the right. The two first screen displays portray the same list of first subject identifiers but associated with different first subject data items corresponding to different data categories of different columns of the source data object. The screen to the left in FIG. 9 is identical to the screen display of FIG. 8.

It will be appreciated that the two first screen displays both show the same list of first subject identifiers associated with different first subject data items. In the first screen display on the left, the first subject data items are totals for Year to Date Sales, and in the first screen display on the right, the first subject data items are totals for sales in the Pipeline. For instance, the second subject data item $8,168,374 adjacent to the first subject identifier Financial indicates the total sales in the Pipeline for Financial Clients. The ordering of the first screen displays in the first sequence of screen displays matches that of data categories within the source data object. That is, first screen displays are ordered in the first sequence according to the order of their associated first subject data items in the source data object. More simply stated, in this example, ordering matches the columns of the source data object.

Horizontal scrolling can be effected through user input commands to select horizontal movement either to the left or to the right through the first sequence. For instance, in some embodiments a user who had been viewing the first screen display on the left in FIG. 9 can cause the device to transition to the first screen display on the right by providing a user input command involving swiping from right to left across the device display screen. Conversely, in some embodiments, a user who had been viewing the first screen display on the right can cause the device to transition to the first screen display on the left by providing a user input command involving swiping from left to right across the device display screen. Thus, a user may navigate horizontally through a sequence of first screen displays in which the first subject data items of different first screen displays correspond to different data categories corresponding to different columns of the source data object.

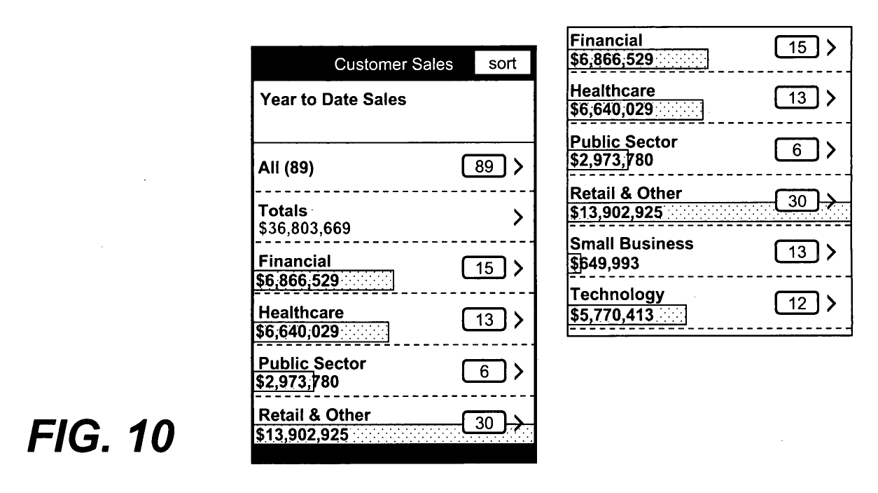

FIG. 10 is an illustrative drawing of the first screen display shown in FIG. 8 and shown on the left in FIG. 9 the listed first subject identifiers and corresponding first subject items in two different vertical scroll positions and showing a bar chart overlay in accordance with some embodiments of the invention. A user may provide an input command such as swiping the device display screen shown on the left in FIG. 10 in a vertically upward direction in order to cause the image on the display screen to scroll upward to the image shown on the right in FIG. 10. In this example, the upward swipe causes the heading and navigation dots and summary data (i.e. “All”) to disappear from the first screen display on the left in FIG. 10 and causes the Small Business and Technology first category elements to come in to view in the first screen display shown on the right in FIG. 10.

A bar chart overlay is provided for each of the first subject data items associated with the first subject identifiers. In this example, the first subject data items comprise dollar amounts. The dollar amounts are visible beneath the overlaying bar charts, and the size (width in this case) of each bar chart overlay is proportional to the magnitude of the dollar amount that it overlays. Thus, the bar charts provide a graphical indication of the relative magnitudes of the amounts associated with each first subject data item.

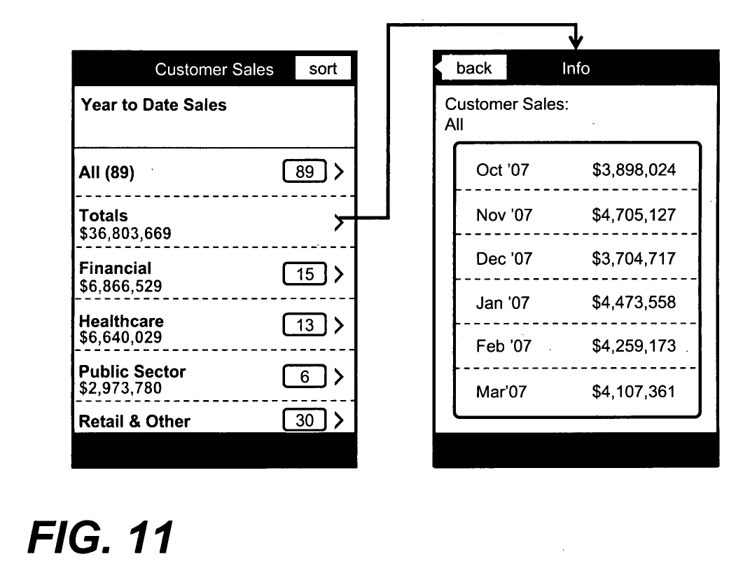

FIG. 11 is an illustrative drawing showing the first screen display of FIG. 8 on the left and showing a screen display showing a Totals screen display that provides a drill-down to combined monthly dollar amount totals for All Business Units Total in accordance with some embodiments of the invention. In particular, the Totals entry in the first screen display on the left shows a Year to Date Sales Total for all categories of Business Units, and the monthly Totals drill-down view on the right shows a list of entries each showing Total monthly sales for a given month for all categories of Business Units. A user may input a command to cause the device to transition its display screen from the first screen display on the left to the drill-down display on the right. For example, such user input command may involve tapping near a region of the device display screen that portrays the Total, $36,803,669. Note that the amounts shown in the display screen on the right may be derived from a data source such as the object of FIGS. 2A-2C and may not actually be directly provided in such object. The Totals drill-down screen display shown on the right includes a user interface button labeled ‘back’, which a user can actuate in order to return to the first screen display shown on the left. Note that the navigation dots are not shown in the screen on the right since this drill-down view does not correspond to a display in the first sequence of displays.

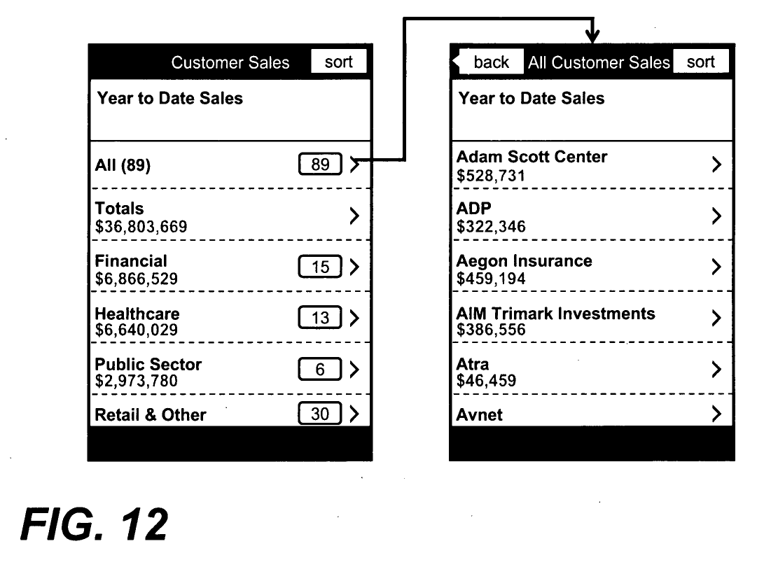

FIG. 12 is an illustrative drawing showing the first screen display of FIG. 8 on the left and on the right, a screen display showing a listing of Year to Date Sales for each Client in accordance with some embodiments of the invention. In particular, the view on the left shows a Year to Date Sales Totals for each first subject identifier, i.e. for each Business Unit, and an ‘All Clients drill-down’ screen display on the right shows total sales for every Client for all Business Units, listed in alphabetical order, which corresponds to the order in which Business Units are portrayed in the illustrative source data object. Note, however, that a user can sort the list of Business Units so that they are displayed in a different order. The list of Clients in the ‘All Clients drill-down’ screen will match whatever sort order a user selects. A user may input a selection command to cause the device to cause its display screen to show the individual Client Year to Date Totals by selecting the first subject identifier labeled All by, for example, tapping near a region of the device display screen displaying the word All. In response, the device produces the ‘All Clients drill-down’ screen display shown on the right. The ‘All Clients drill-down’ user interface screen display includes a user interface button labeled ‘back’, which a user can actuate in order to return to the first screen display shown on the left. Note that the first navigation dot is highlighted in both the display on the left and the display on the right indicating that both pertain to same position in the ordering of first screen displays, i.e. Year to Date Sales, albeit at two different levels of detail. Also, note that the amounts shown in the display screen on the right may be derived from a data source such as the illustrative object of FIGS. 2A-2C and may not actually be directly provided in the object.

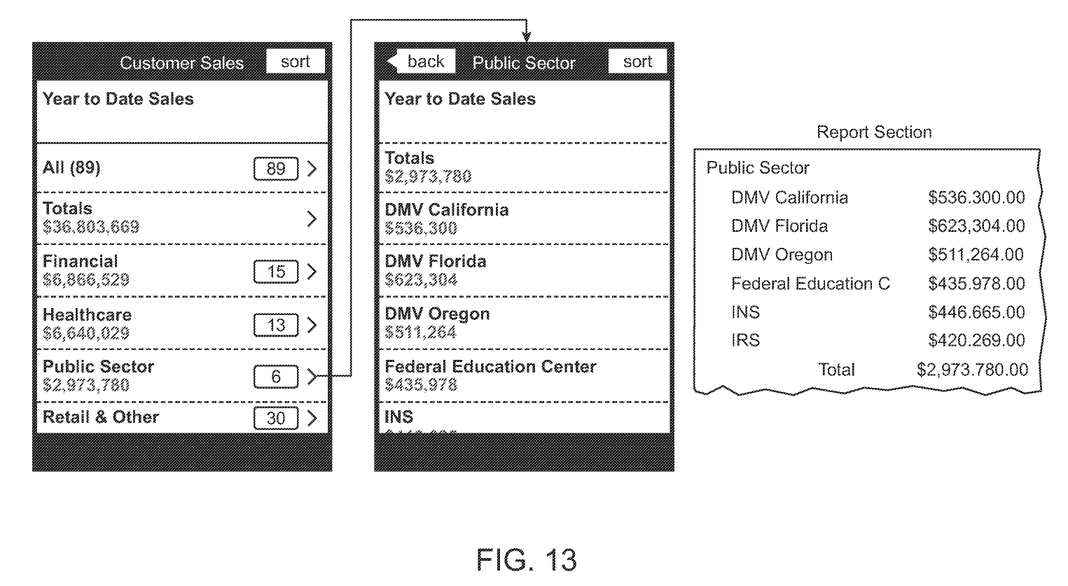

FIG. 13 is an illustrative drawing showing the first screen display of FIG. 8 on the left and showing a second screen display on the right that shows a drill-down to a list that comprises a set of second subject identifiers labeled with Client names that are associated with the first subject identifier labeled Public Sector Business Unit in accordance with some embodiments of the invention and also showing a corresponding portion of a source data object. A user may input a command to cause the device to transition from a display of the first screen display screen on the left to the second screen display on the right by selecting the first subject identifier labeled Public Sector by, for example, tapping near a region of the first screen display on the left showing the first subject identifier, Public Sector, and showing the first subject data item, $2,973,780. The second screen display includes a list of second subject identifiers, i.e., Clients encompassed within the Public Sector Business Unit and corresponding second subject data items, i.e., Year to Date Totals for each Client. For example, the total sales attributed to DMV California is $536,300. The second screen display on the right also indicates that the total sales attributed to all Clients within the Public Sector Business Unit is $2,973,780.

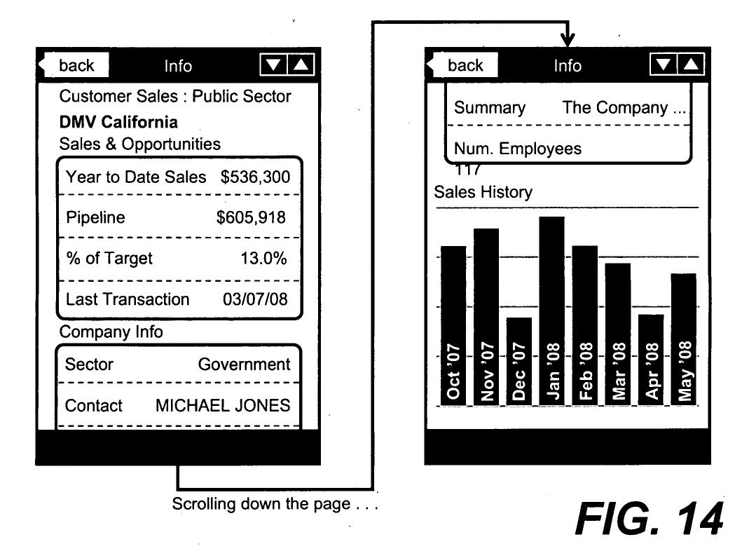

FIG. 14 is an illustrative drawing showing a third screen display in two different vertical scroll positions, on the left and on the right, that includes the second subject identifier DMV California and multiple second subject data items from different data categories within different columns of the row of the source data object that correspond to the subject identifier DMV California in accordance with some embodiments of the invention. The third screen display of FIG. 14 is produced by the device in response to a user selection of a second subject identifier DMV California in the second screen display shown on the right in FIG. 13. More specifically, the third screen display includes second subject data items, Year to Date Sales $536,300, Pipeline $605,918, % of Target 13.0%, Last Transaction Mar. 7, 2008, etc. from the row of the source data object that corresponds to the second subject identifier DMV California. Thus, both column heading information from the source data object and data values from the source data object are included in the third screen display of FIG. 14. The multiple second subject data items of FIG. 14 are displayed in three groups labeled Sales & Opportunities, Company Info and Sales History. The second subject data items and the groups are listed vertically all under the label DMV California. This level of drill-down view in which groups of data from different rows of the tabular data are shown is referred to herein as a ‘card’ view. Each group is shown to include a vertically oriented list of second subject matter data items and corresponding labels from the tabular data.

The display screen is too small to show all three groups associated with the DMV California card view simultaneously on the screen display. In some embodiments, a user can provide an input to the device to cause the device to scroll vertically between the potion of the DMV California third screen display shown on the left and the portion shown on the right by vertically swiping across the device display screen. The Sales History group appearing on the third screen display portion shown on the right includes second subject data items representing monthly sales data with bar chart overlays to provide a visual representation of the relative differences in sales for different months. The bar charts provide a graphic visual indication of the relative sales volumes during different months. The third screen display labeled DMV California includes a user interface button labeled back, which a user can actuate in order to return to the view shown on the right in FIG. 13. It also includes up/down buttons used to vertically scroll to other cards, which are ordered alphabetically or in whatever sort order has been selected by a user, identically to the ordering of the list of second subject identifiers set forth in the second screen display of FIG. 13.

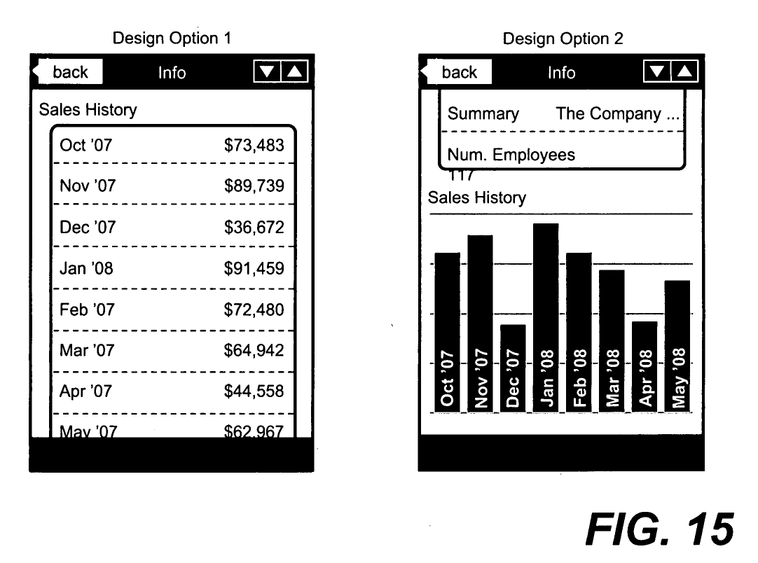

FIG. 15 is an illustrative drawing showing two alternative third screen display versions of the Sales History group of the DMV California card view. The version on the right is identical to the display on the right in FIG. 14. The version on the left shows monthly sales for DMV California in a vertical list format.

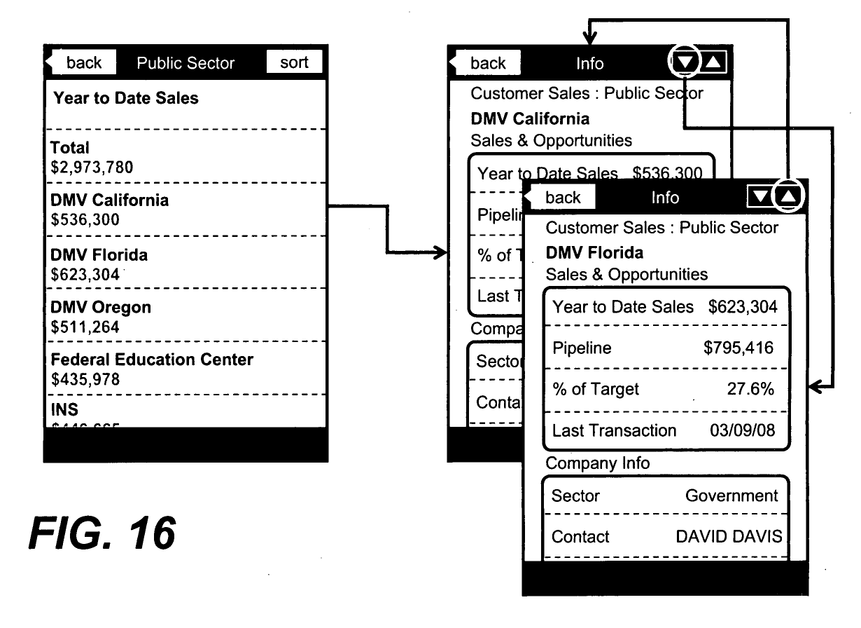

FIG. 16 is an illustrative drawing showing a screen display transition responsive to user selection of the second subject identifier, DMV California, in the second screen display labeled, Public Sector Year to Date Sales, and showing screen transitions responsive to user selections between the third screen display, labeled DMV California and the third screen display labeled DMV Florida in accordance with some embodiments of the invention. As explained above, when the device display screen shows the second screen display shown on the left in FIG. 9, a user may command the device to produce the DMV California card by tapping or clicking near a region of the display corresponding to the second subject identifier, DMV California, for example. Once the device display screen shows the third screen display labeled, DMV California (the DMV California card), the user can command the device to produce the DMV Florida card by selecting the down arrow on the DMV California card. Conversely, when the display screen shows the DMV Florida card, the user can command the device to change the displayed view to the DMV California card by selecting the up arrow on the DMV Florida card. Note that the card views are ordered in the order indicated on the second screen display view labeled, Public Sector, shown on the left.

### Overview of Data Structure of an Illustrative Embodiment

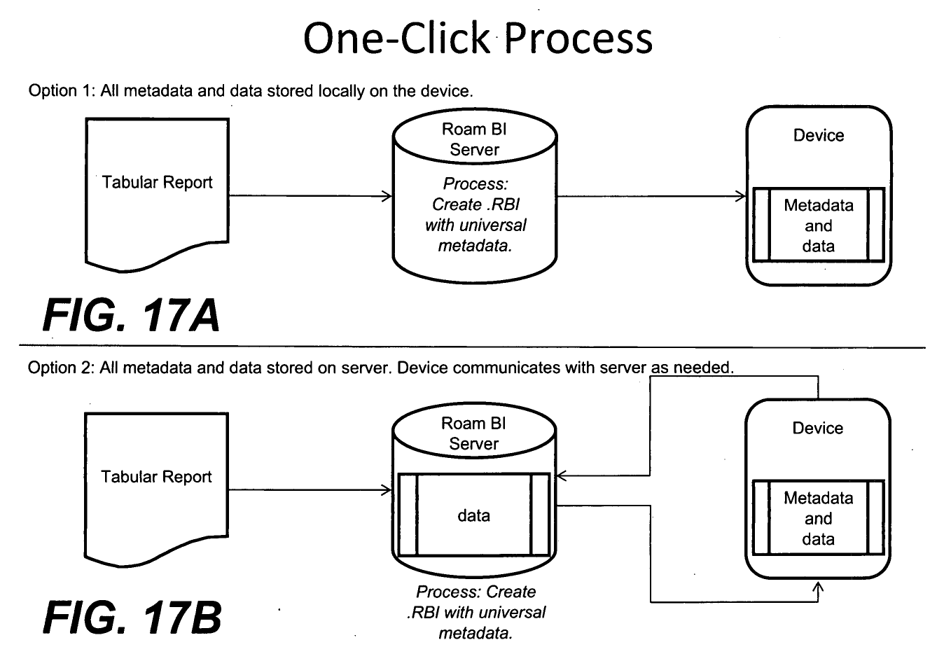

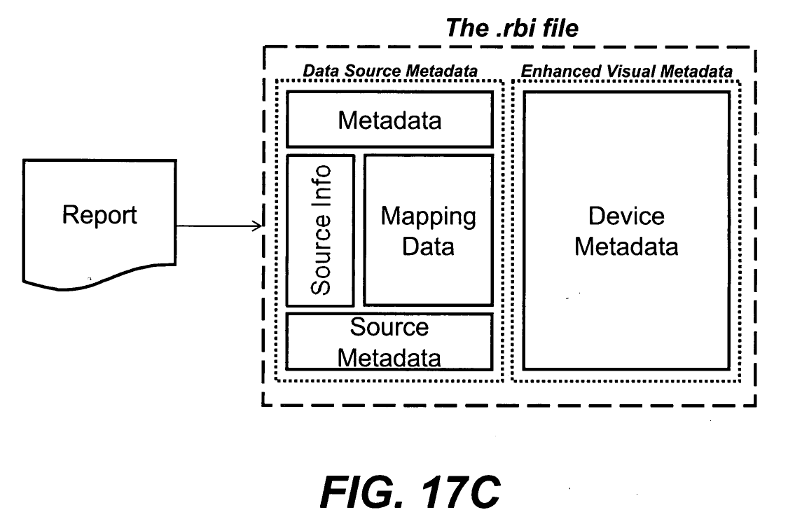

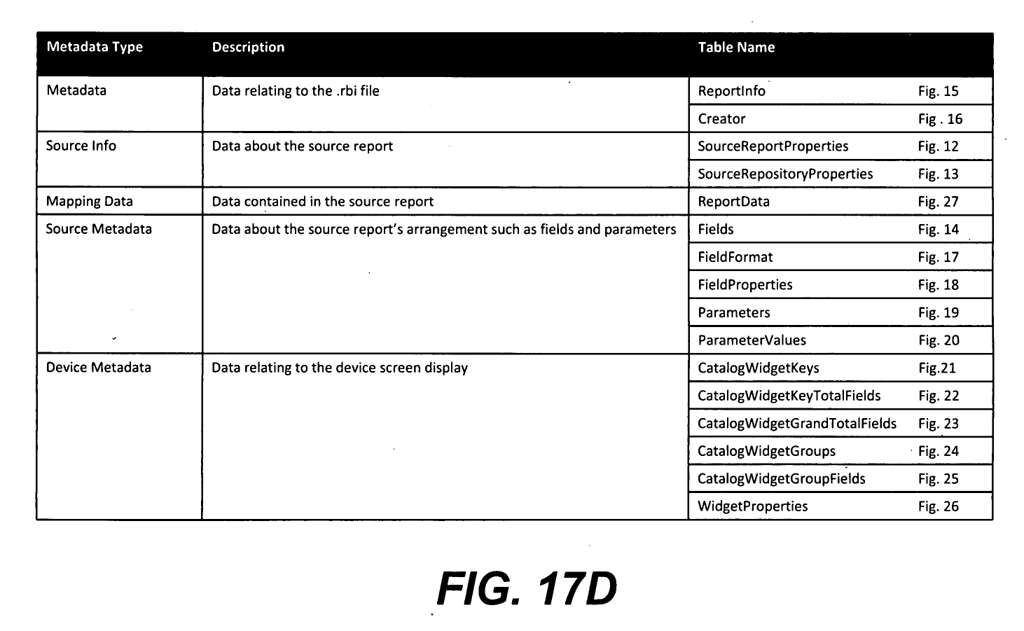

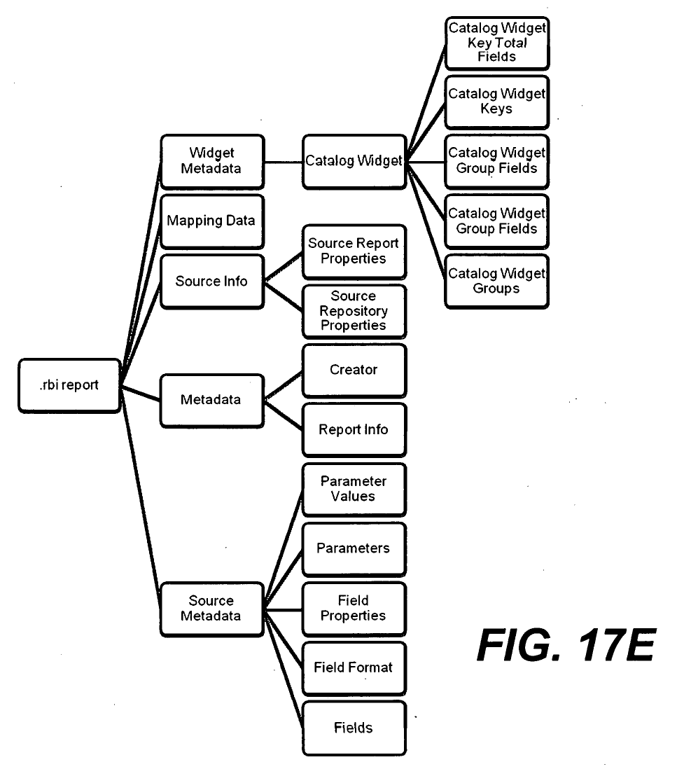

FIGS. 17A-17B are illustrative drawings representing processes to produce a data structure that includes mapping data based upon source data and metadata used to map the mapping data to screen display images in response to user input commands and to transmit such data structure to a user device. FIG. 17A illustrates a first process that includes input of source data to a server used to create corresponding data structure with mapping data and metadata and transmission of the entire data structure to a user device. The first process permits transmission of substantially all of both the data structure from server to the user device. A user then can access the data structure offline without need to access the server for additional information, for example. FIG. 17B illustrates a similar second (i.e., alternative) process that includes input of source data to a server used to create the data structure. In the second process, however, the data structure including the mapping data and the metadata are communicated to the user device as needed or on demand, rather than all at once. That is, user interaction prompts retrieval of a next-needed data. More particularly, queries will be run based on the users interaction. Only the information needed to be displayed will be returned at any given time. Retrieving data on an as needed basis can speed processing since time is not lost retrieving information that is not required by the user. This second process can be advantageous for use with larger source data objects, for example.

In some embodiments, the data structure including the mapping data and metadata are organized to provide relational data structure comprising object structures. In particular, in some embodiments, structure of the data structure complies with an SQLite format. In such SQLite format, in some embodiments, the mapping data comprises a mapping object that includes the first and second subject data items from the source data object, and the metadata comprise a plurality of metadata objects (15 in a present embodiment) to control the production of the screen displays of FIGS. 8-16 from the mapping data.

FIGS. 17C-17D are illustrative diagrams representing a file produced in accordance with the processes of FIGS. 17A-17B. The file is that is encoded in a computer readable storage medium in accordance with some embodiments of the invention. FIG. 17C shows that the file is produced from a source report containing source data such as that of FIGS. 2A-2C, for example. The source data is mapped to a object structure that comprises groups of objects generally characterized as data source metadata and device display screen metadata. FIG. 17D illustrates categories in which different objects in the file are organized.

FIG. 17E is an illustrative entity relational diagram representing relationships among objects show in FIGS. 17C-17D in accordance with some embodiments of the invention. The objects in the diagram can represent tables, for example.

### Metadata Tables of an Illustrative Embodiment

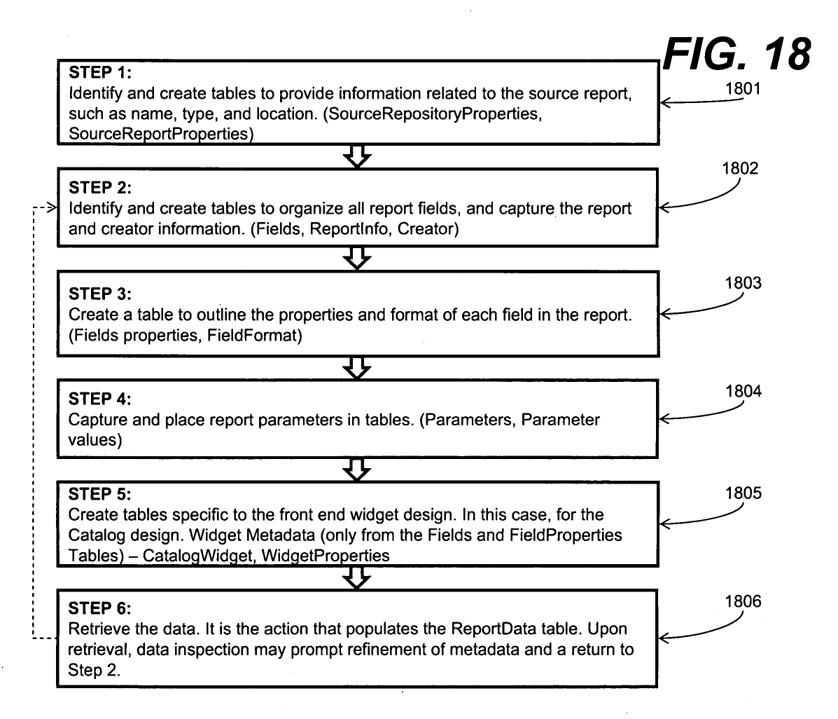

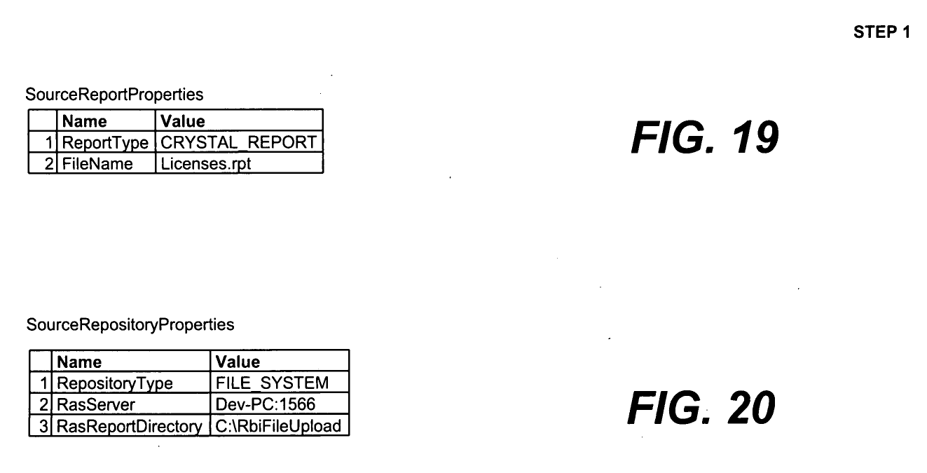

FIG. 18 is an illustrative flow diagram of a process to create metadata tables and mapping data object in accordance with some embodiments of the invention. For example, initially a source report such as the source report of FIGS. 2A-2C, in a given format is manually converted to a file of the type illustrated in FIGS. 17C-17D. Thereafter, subsequent source reports in that same given format are converted automatically to the type of file in FIGS. 17C-17D using computer program code encoded in computer readable storage media. The process is implemented using computer program instructions encoded in computer readable medium associated with the server executed by a computer system. FIG. 19 is an illustrative drawing of a SourceReportProperties object created using block 1801. FIG. 20 is an illustrative drawing of a SourceRepositoryProperties object created using block 1801. These two objects provide information relating to the source data object data including, name type and location.

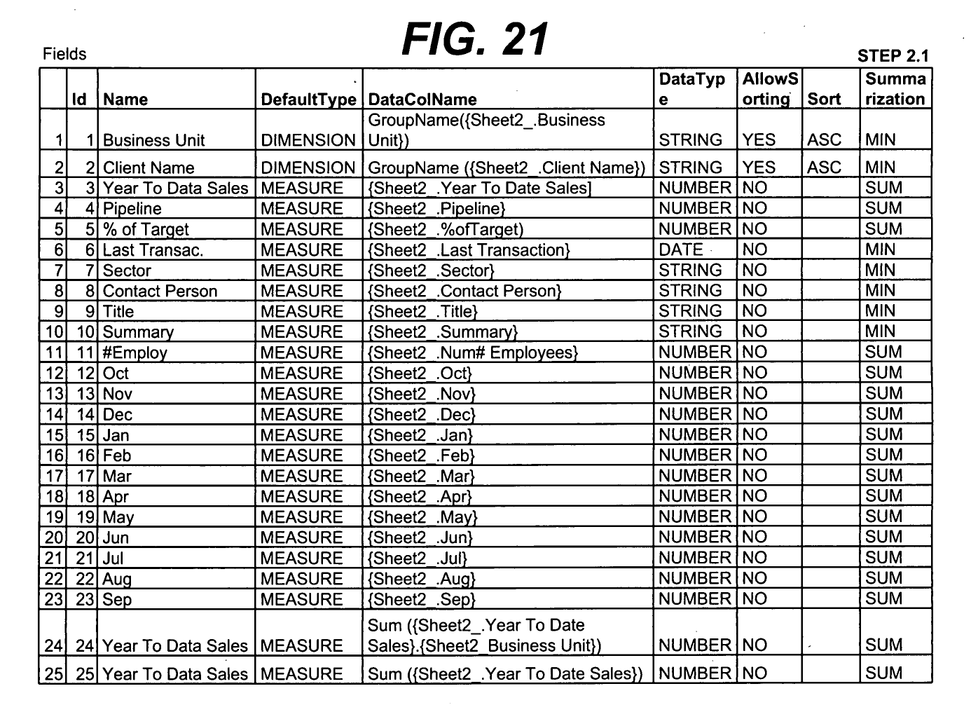

FIG. 21 is an illustrative drawing of a Fields object created using block 1802 of the process of FIG. 18. The Field object serves as a data structure used create associations involving different combinations of first and second subject data identifiers and first and second subject data items. Field identifiers (Id's) within the Field object serve as data structure elements that can be associated with source data to demarcate different categories of data, for example. Names in the Field object appear as labels in the user interface screen display that identify first and second subject identifiers and that identify first and second subject data items.

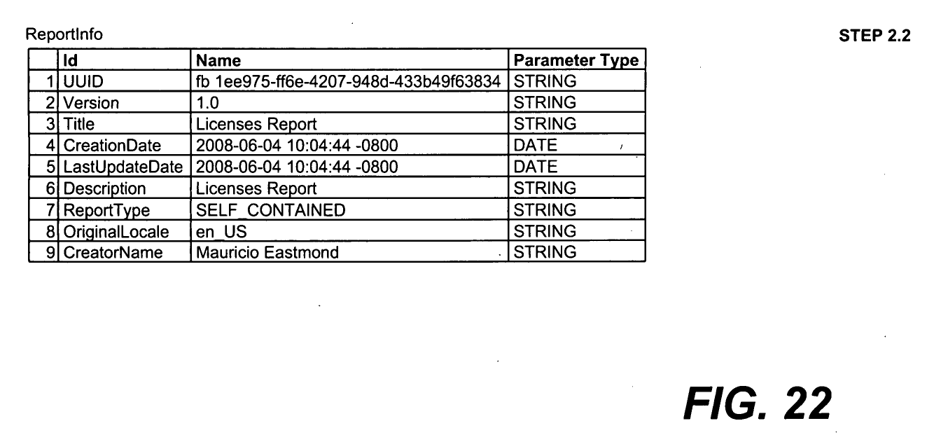

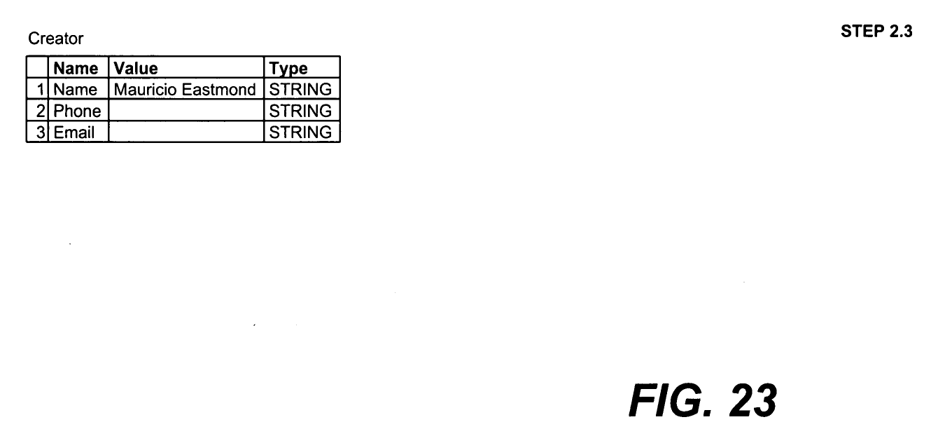

FIG. 22 is an illustrative drawing of a ReportInfo object created using block 1802. FIG. 23 is an illustrative drawing of a Creator object created using block 1802. These three objects provide information to organize all report fields, to capture report information and to capture report creator information.

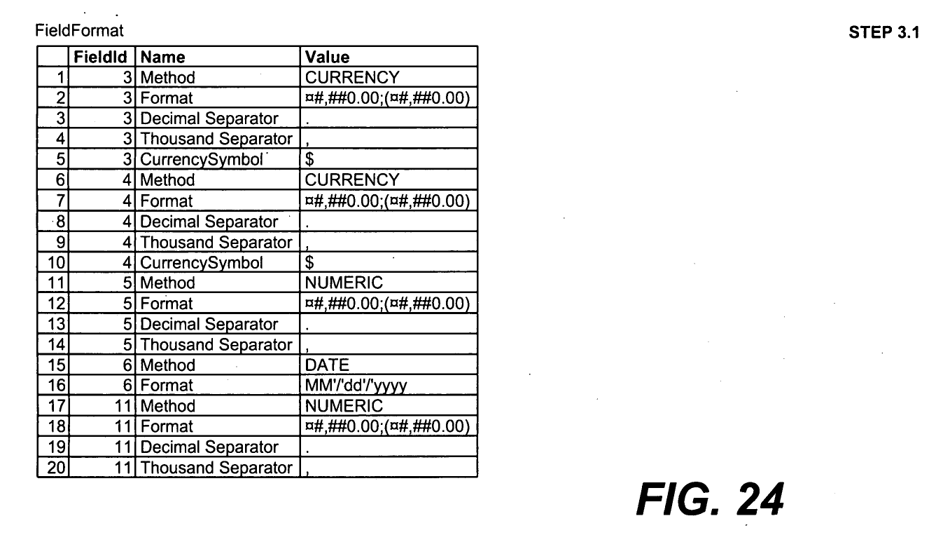

FIG. 24 is an illustrative drawing of a FieldFormat object created using block 1803 of the process of FIG. 18. Source data within different fields may be presented in different formats, and the FieldFormat object identifies the different formats used for different fields.

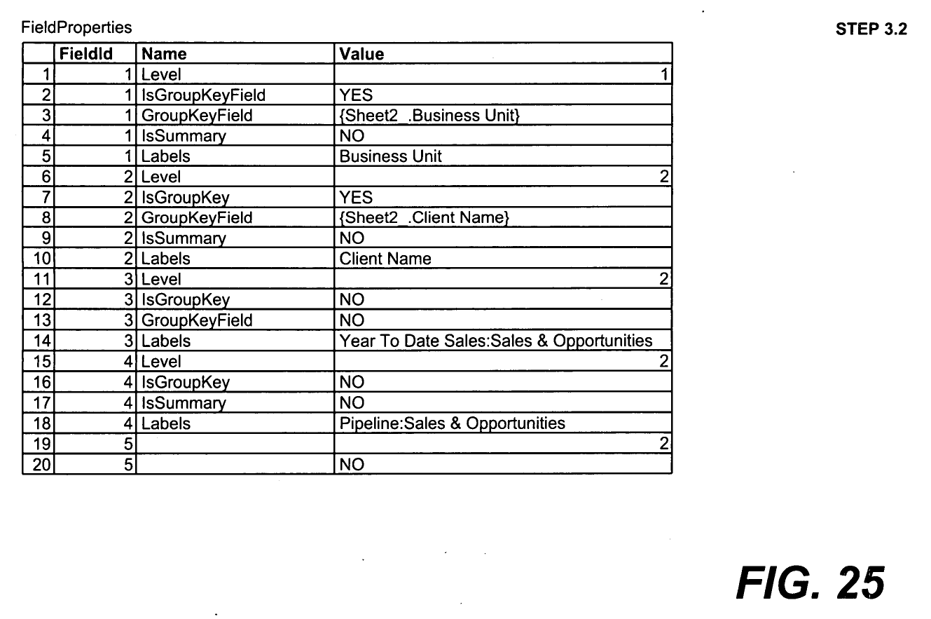

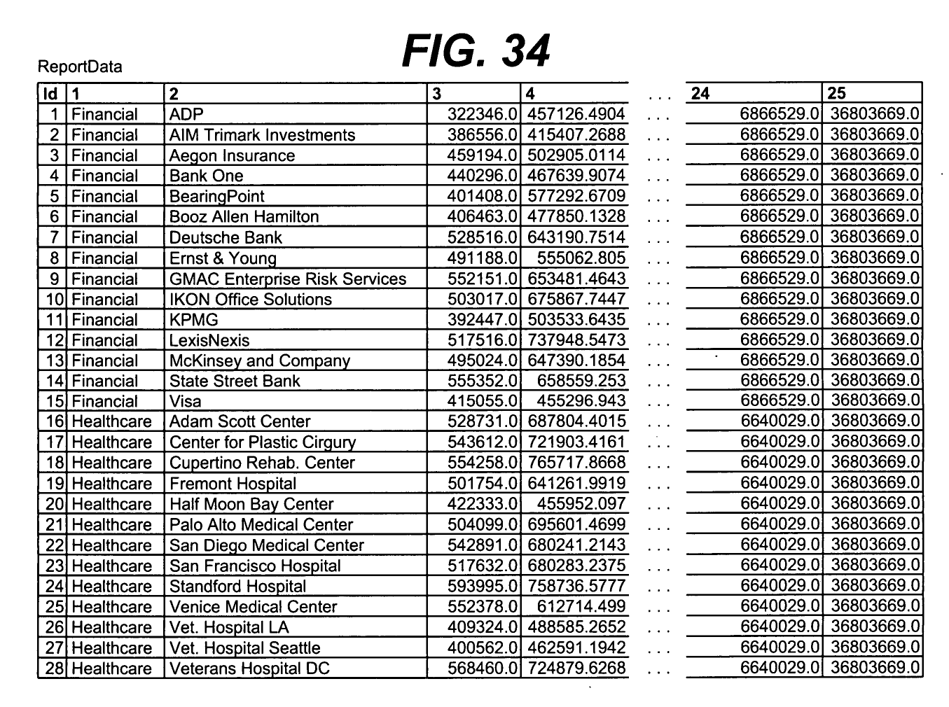

FIG. 25 is an illustrative drawing of a FieldProperties object created using block 1803. The FieldProperties object serves as a data structure to indicate which fields serve as group key fields and to indicate the level in the screen display at which data associated with the is to be presented. FieldProperties provide details for each of the FieldIds within the ReportData (FIG. 34). “FieldId” references the column within ReportData. “Name” represents the property type and “Value” provides the details of that property. For example, where “IsGroupKeyField” is “YES,” this indicates which FieldIds are keys. This is the case for FieldIds 1 and 2. The significance of keys is that these are the subject identifiers. Here, Business Unit is the first subject identifier and Client Name is the second subject identifier.

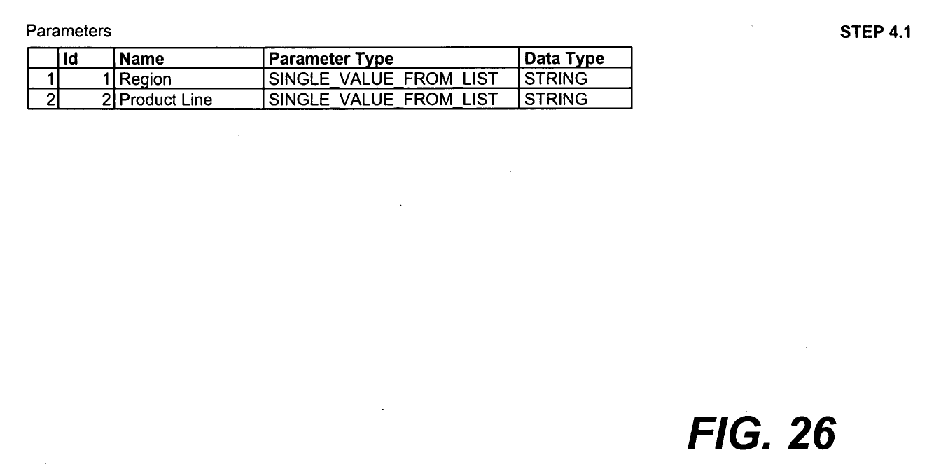

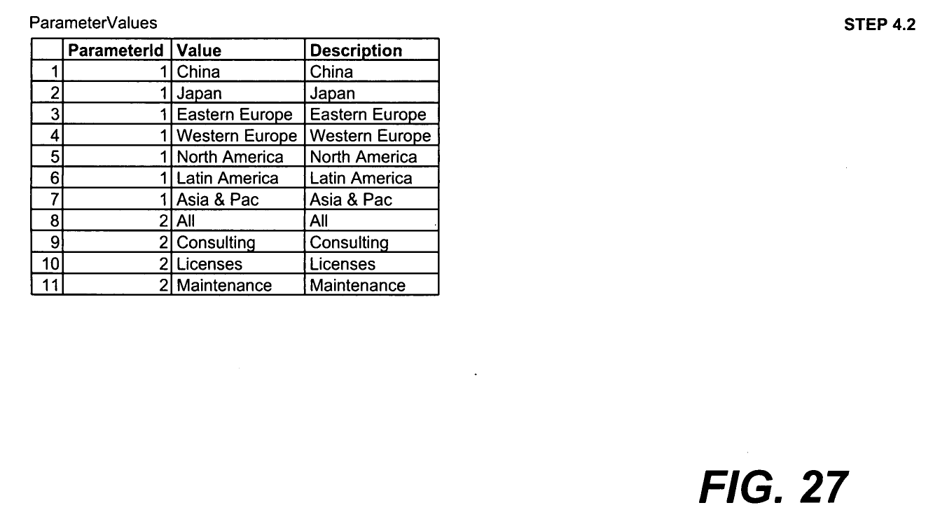

FIG. 26 is an illustrative drawing of a Parameters object created using block 1804 of the process of FIG. 18. FIG. 27 is an illustrative drawing of a ParameterValues object created using block 1804. These two objects capture source tabular data parameters.

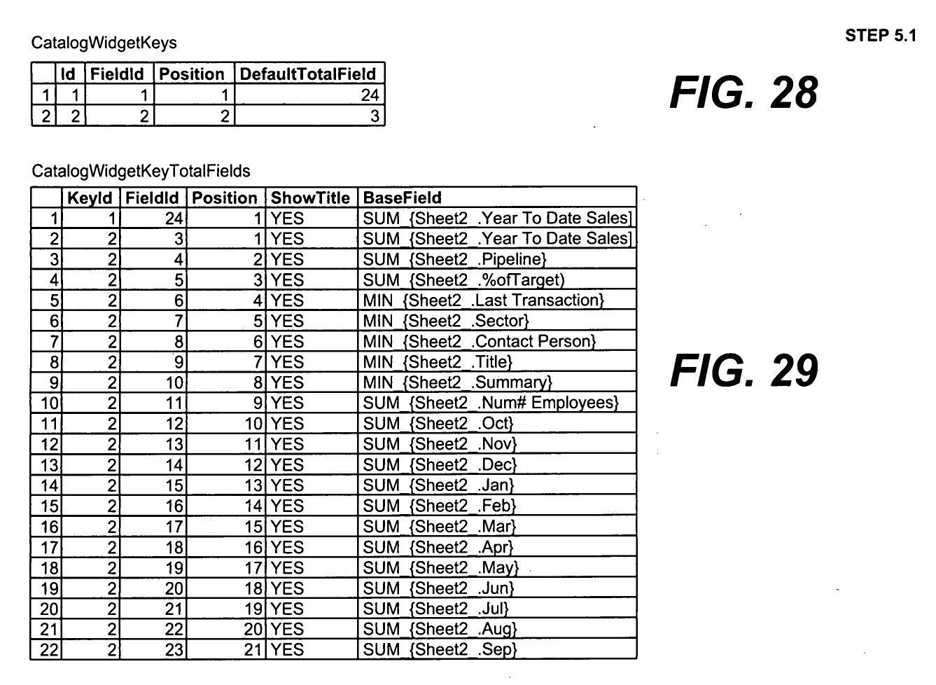

FIG. 28 is an illustrative drawing of a CatalogWidgetKeys object created using block 1805 of the process of FIG. 18. In the illustrated embodiment, the ‘widget’ comprises a user interface screen displays. In a present embodiment, the CatalogWidgetKeys object associates first subject identifiers that correspond to FieldId 1 with Key Id 1. The CatalogWidgetKeys object also associates second subject identifiers that correspond to FieldId 2 with Key Id 2. The Position indicates ordering of the presentation in a set of screen displays of subject identifiers associated with the key fields. In the illustrated embodiment, first subject identifiers associated with FieldId 1 are presented before second subject identifiers associated with FieldId 2. The DefaultTotalField indicates the field that contains default subject data items. For the first subject identifiers of FieldId 1, the default first subject data items are provided in Field 24. For the second subject identifiers of FieldId 2, the default second subject data items are provided in Field 3.

FIG. 29 is an illustrative drawing of a CatalogWidgetKeyTotalFields object created using block 1805. The CatalogWidgetKeyTotalFields object provides indicia of associations between first subject data items associated with FieldId 24 and first subject identifiers associated with KeyId 1. The CatalogWidgetKeyTotalFields object also provides indicia of associations between second subject data items associated with FieldIds 3-23 and second subject identifiers associated with KeyId 2.

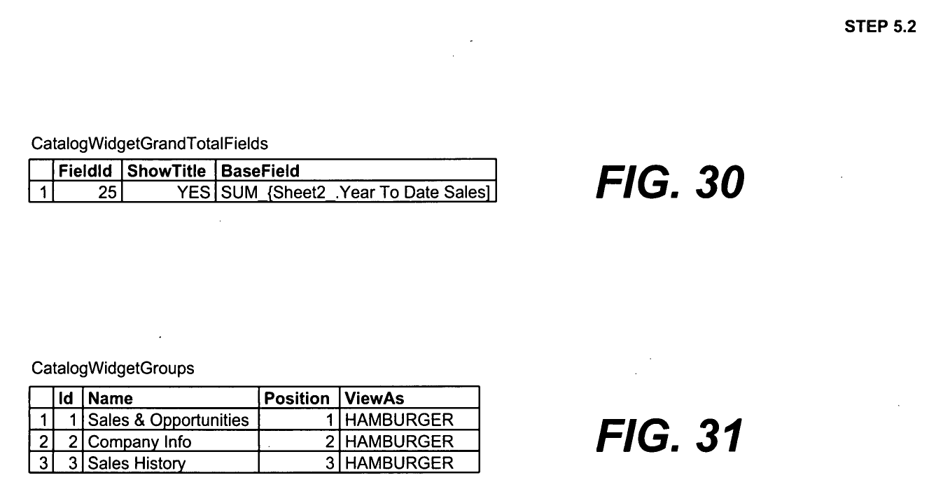

FIG. 30 is an illustrative drawing of a CatalogWidgetGrandTotalFields object created using block 1805. FIG. 31 is an illustrative drawing of a CatalogWidgetGroups object created using block 1805.

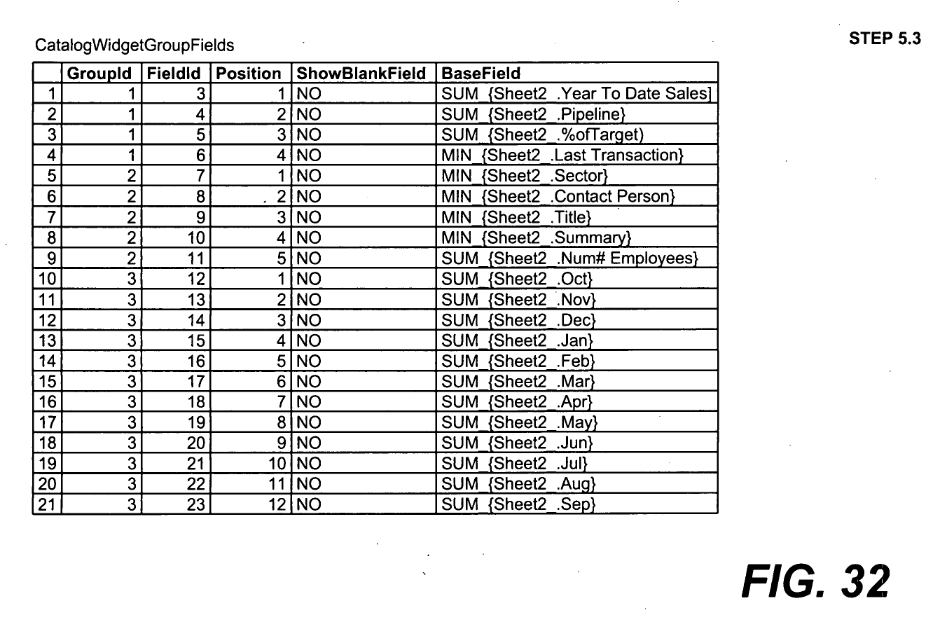

FIG. 32 is an illustrative drawing of a CatalogWidgetGroupFields object created using block 1805. The CatalogWidgetGroupFields object provides indicia of associations among second subject data items so as to define multiple groupings of second subject data items, the result creates screens such as FIG. 6.

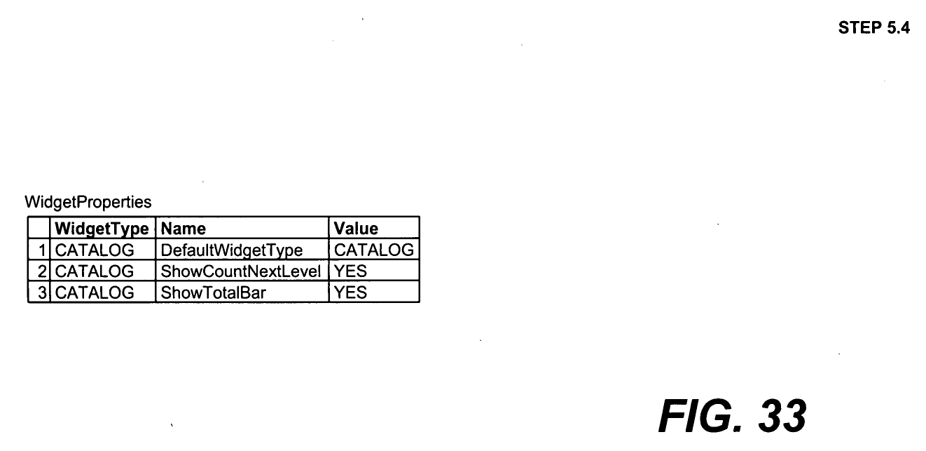

FIG. 33 is an illustrative drawing of a WidgetProperties object created using block 1805.

FIG. 34 is an illustrative drawing of a portion of an example ReportData object in accordance with some embodiments of the invention. The ReportData object also is referred to herein as a mapping object. Block 1806 of FIG. 18, retrieves data from a source data object such as that of FIGS. 2A-2C to assemble the ReportData (i.e., mapping) object of FIG. 34. Recursion to block 1802 may be required for more free-form data sources where the data within the ReportData is used to complete some of the previously described objects. The example mapping object is too large to display in its entirety in this drawing. Information from the source is input to the mapping object.

It will be appreciated that the list of Fields 1-25 in the Fields object of FIG. 21 and the ordering of those fields 1-25 in the ReportData object of FIG. 34 provide indicia of ordering among the first and second data items.

Moreover, it will be understood that the organization of first subject identifiers and second subject identifiers in the ReportData object of FIG. 34 provides indicia of associations between such first subject identifiers and sets of second subject identifiers. For example, the Business Unit named Financial (a first subject identifier) is associated in the ReportData object with ADP, AIM Trimark Investments, Aegon, . . . Visa (an associated set of second subject identifiers).

### Example of Use of Data Structure to Produce Screen Displays

In response to user input commands, the objects of FIGS. 19-33 interact with the mapping data object (FIG. 34) to produce the screen displays described with reference to FIGS. 8-16.

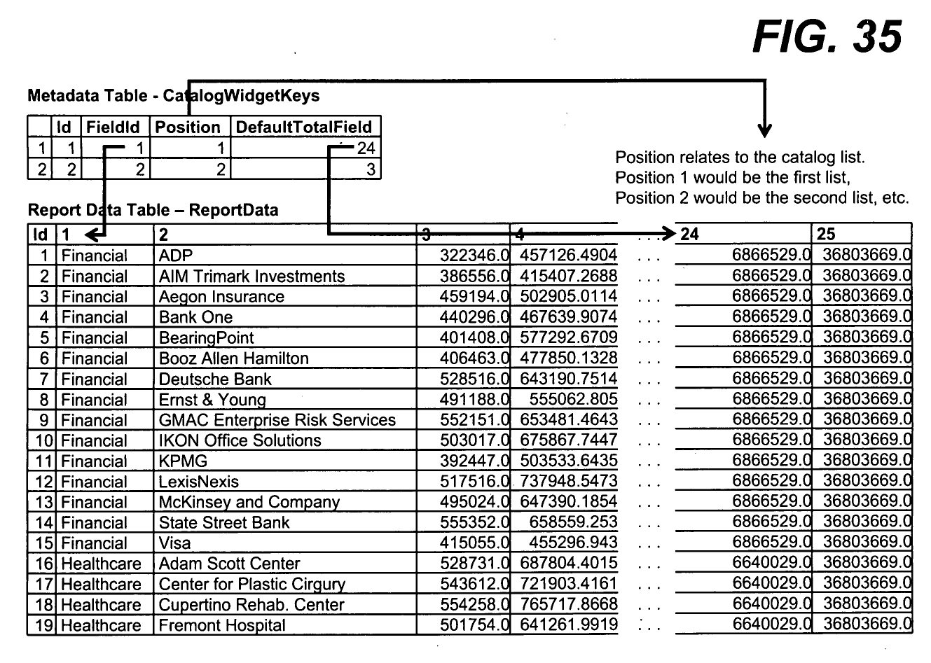

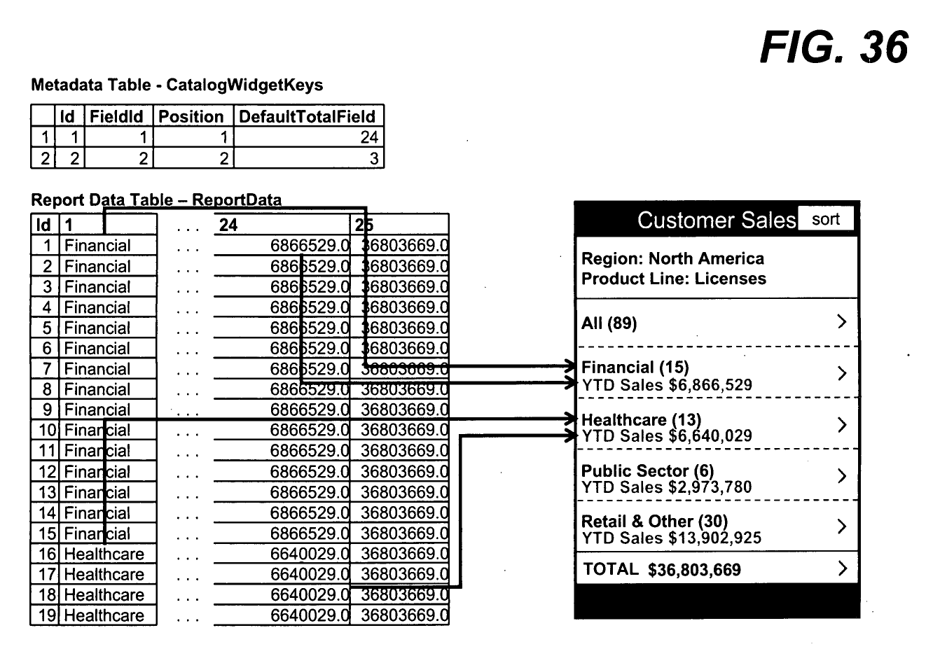

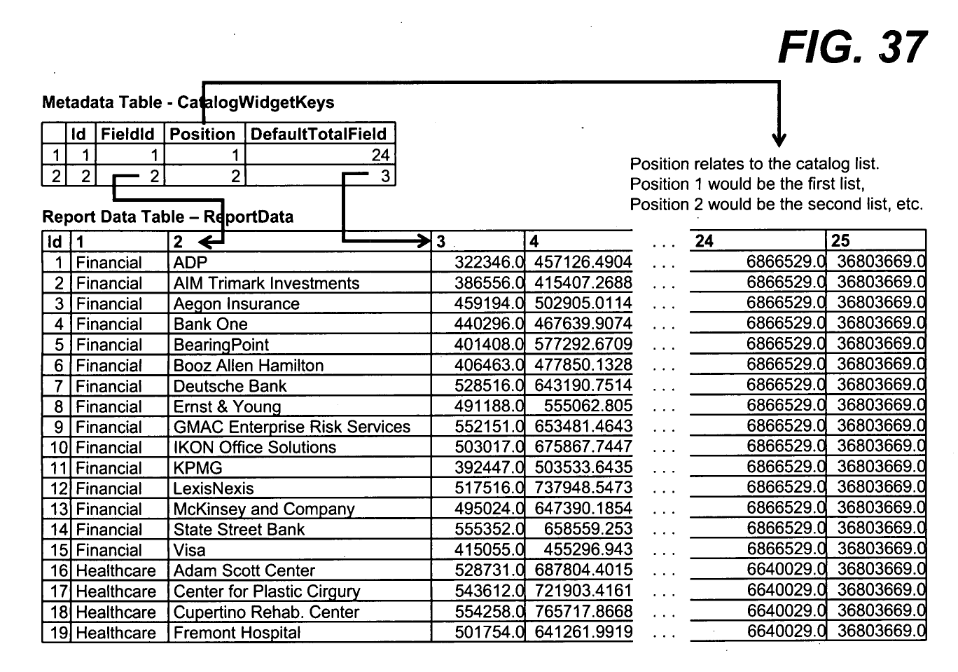

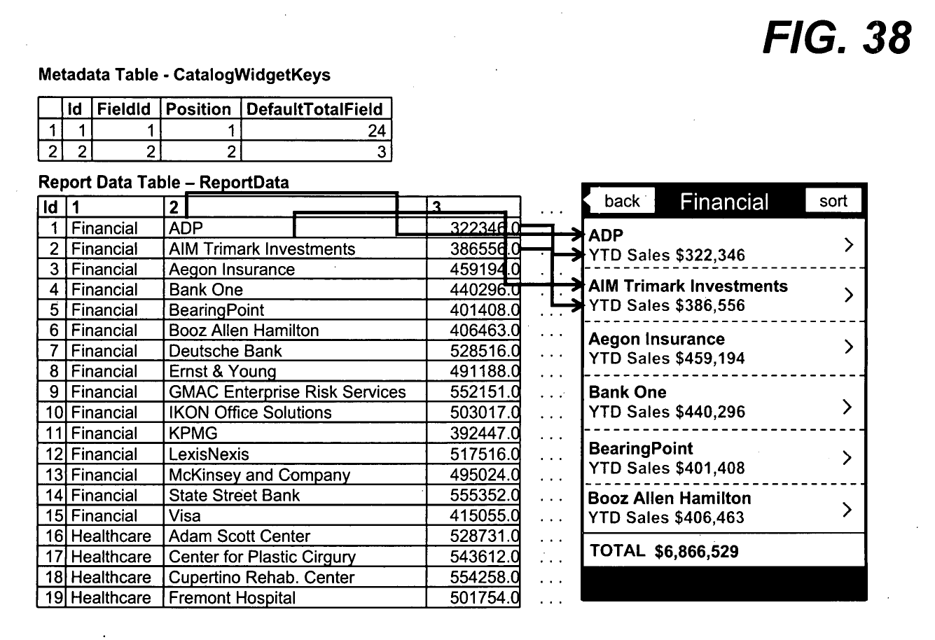

FIGS. 35-38 are illustrative drawings showing relationships between the CatalogWidgetKeys object of FIG. 28 and the mapping data object of FIG. 34 used to produce an illustrative first level screen display of a first sequence of screen displays (FIGS. 35-36) and used to produce an illustrative second level screen display of a second sequence of screen displays (FIGS. 37-38).

Referring to FIG. 35, the column of the CatalogWidgetKeys object with the heading FieldId contains key value entries. The column of the ReportData (mapping) object with FieldId 1 (which according to the Fields object of FIG. 21 comprises Business Units) contains a list of first subject identifiers (Financial, Healthcare, etc.). The column of the ReportData (mapping) object identified as FieldId 24 contains first subject data items, specifically dollar totals per Business Unit. The CatalogWidgetKeys object column having the heading DefaultTotalField indicates the column of the ReportData object that contains Business Unit dollar totals. In the illustrated embodiment, the CatalogWidgetKeys object provides indicia that the first subject data identifiers corresponding to FieldId 1 in the ReportData object are associated with the first subject data items of column 24 of the ReportData object.

Referring to FIG. 37, the column of the ReportData (mapping) object with FieldId 2 (which according to the Fields object of FIG. 21 comprises Client Names) contains a list of second subject identifiers (ADP, AIM Trimark Investments, Aegon Insurance, etc.). The column of the ReportData (mapping) object identified with FieldId 3 contains second subject data items, specifically dollar totals per Client Name. The CatalogWidgetKeys object column having the heading DefaultTotalField indicates the column of the ReportData object that contains Client Name dollar totals. In the illustrated embodiment, the CatalogWidgetKeys object provides indicia that the second subject data identifiers corresponding to FieldId 2 in the ReportData object are associated with the second subject data items of column 3 of the ReportData object.

FIG. 36 is an illustrative drawing showing a structural relationship, dictated by the first row of the metadata object CatalogWidgetkeys, between subjects in field 1 (column 1) of the metadata object and first level subject identifiers in an illustrative first screen display, and also showing a structural relationship, dictated by the first row of the metadata object CatalogWidgetkeys, between numbers in field 24 of the metadata object and first subject data items in the illustrative first screen display. For example, the first subject data item $6,866,529 associated with the first subject identifier Financial in the first screen display shown in FIG. 36 matches 6866529.0 appearing in the rows of the column headed 24 that also contain Financial in the column headed 1 in the portion of the mapping data object shown in FIG. 36. Likewise, for example, the first subject data item $6,640,029 associated with the first subject identifier Healthcare in the first in the first screen display shown in FIG. 36 matches 6640029.0 appearing in the rows of the column headed 24 that also contain the Healthcare in the column headed 1 in the portion of the mapping data object shown in FIG. 36.

FIG. 38 is an illustrative drawing showing a structural relationship, dictated by the second row of the metadata object CatalogWidgetkeys, between subjects in field 2 (column 2) of the metadata object and second subject identifiers in an illustrative second screen display, and also showing a structural relationship, dictated by the second row of the metadata object CatalogWidgetkeys, between numbers in field 3 of the metadata object and second subject data items in the illustrative second screen display. For example, the second subject data item $322,346 associated with the second subject identifier ADP in the second screen display shown in FIG. 38 matches 322346.0, which appears in the row of the mapping data object that contains the second subject identifier ADP. Specifically, ADP appears in the column headed 2, and 322346.0 appears in the same row in the column headed 3. Similarly, the second subject data item $386,556 associated with the second subject identifier AIM Trimark Investments in the second screen display shown in FIG. 38 matches 386556.0, which appears in the row of the mapping data object that contains the second subject identifier AIM Trimark Investments. AIM Trimark Investments appears in the column headed 2, and 386556.0 appears in the same row in the column headed 3.

Referring to FIG. 37, the column in the CatalogWidgetKeys object with the heading Position contains values that indicate list structure. The row of the CatalogWidgetKeys containing FieldId value 1 and Position value 1 indicates that the first subject identifiers contained within the column labeled 1 of the mapping data object comprise elements of a first level list in a list hierarchy. Conversely, the row of the CatalogWidgetKeys containing FieldId value 2 and Position value 2 indicates that the second subject identifiers contained within the column labeled 2 of the mapping data object comprise second elements of a second level list in the list hierarchy. Moreover, by indicating the structural ordering or relationship among the lists, the Position values determine which list elements serve as a key index to other lists. Specifically, in this example, the Position values determine that a user selection of a Business Unit from a first screen display results in the device displaying a second screen display that includes Clients within the selected Business Unit. In other words, the Position values indicate that the Business Units comprise a first level in a list hierarchy and the list of Clients comprises a second level in the list hierarchy.

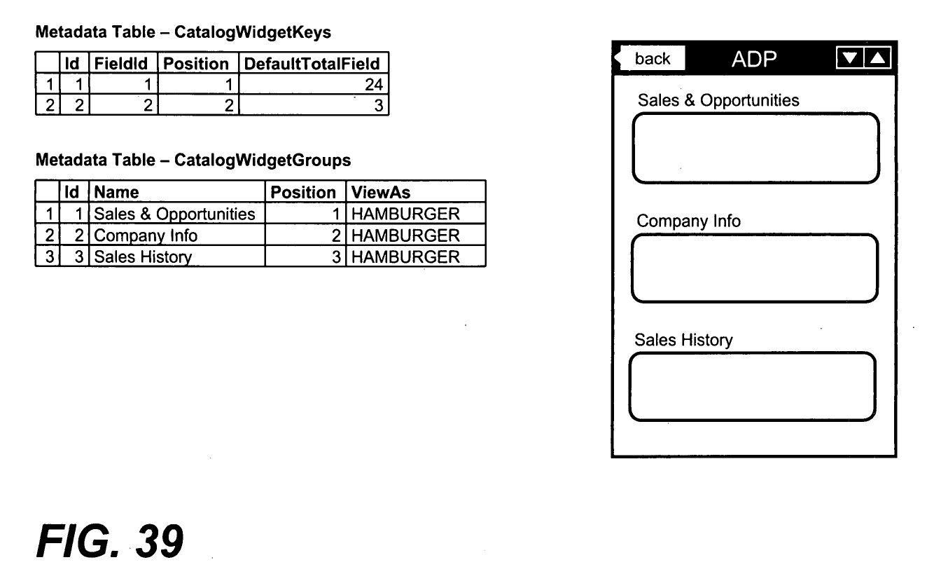

FIG. 39 is an illustrative drawing showing relationships among the CatalogWidgetKeys object and the CatalogWidgetGroups object and layout and organization groups within an illustrative third screen display referred to as the card in accordance with some embodiments of the invention. Implicit in the CatalogWidgetKeys object is that a user selection of an element from a Position level 2 list (i.e., a Client in this example) results in display of a card in which second subject data items are presented in groups. The CatalogWidgetGroups object indicates the groups and the layout structure of the groups within the card display. The column in the CatalogWidgetGroups object headed Name indicates the name of each of the groups; the column headed Position indicates the vertical position of a named group within the card; and the column labeled ViewAs indicates the structural information from the CatalogWidgetGroups object dictates that information from the mapping data object should be laid out in a card view as shown in the illustrative third screen display shown on the right with regions labeled, Sales & Opportunities, Company Info and Sales History as indicated.

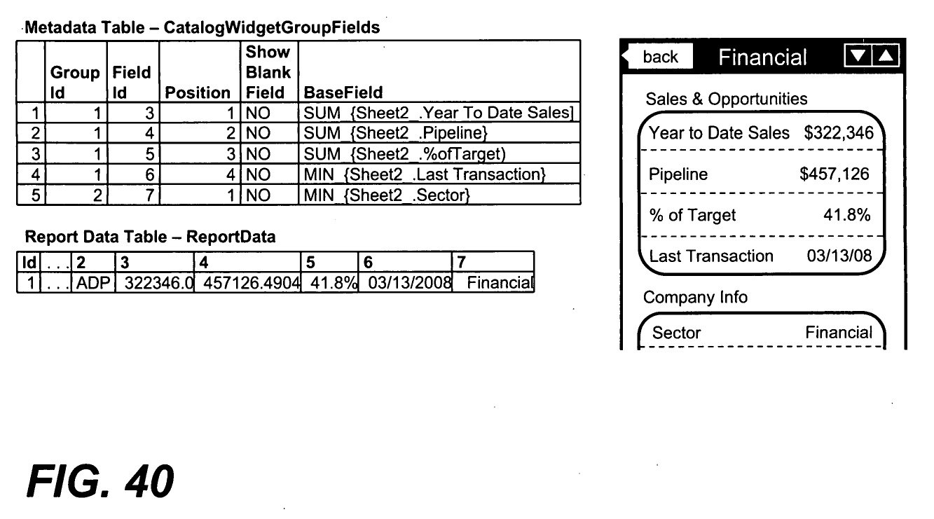

FIG. 40 is an illustrative drawing showing relationships among the CatalogWidgetGroupFields object and the mapping data object and layout and organization of second subject data items within the groups of the illustrative third screen display (card) in accordance with some embodiments of the invention. In this example, it is assumed that a user selected the second subject identifier labeled ADP in the second screen display shown on the right in FIG. 38. The first four rows of the CatalogWidgetGroupFields object indicate that the first listed group labeled Sales & Opportunities comprises second subject data items from the columns headed 3, 4, 5, and 6 in the mapping data object. The labels come from looking up the FieldID from CatalogWidgetGroupFields and matching to the Id on the Field object. FIG. 40 shows a portion of a row of the mapping data object containing the Client name ADP in column labeled 2 and containing 322346 in the column headed 3. The first row of the CatalogWidgetGroupFields object indicates that the first entry of the first group of the card should contain information from the column headed 3 in the mapping data object. As shown, the first entry of the first group contains Year to Date Sales $322,346. The second row of the CatalogWidgetGroupFields object indicates that the second entry of the first group of the card should contain information from the column headed 4 in the mapping data object, which contains 457126.4904. As shown, the second entry of the first group contains Pipeline $457,126. The third and fourth rows of the CatalogWidgetGroupFields object indicate that the respective third and fourth entries of the first group of the card should contain information from the respective column headed 5 and 6 in the mapping data object.

The fifth row of the CatalogWidgetGroupFields object of FIG. 40 indicates that a first entry in the second listed group labeled Company Info comprises a second subject data item from the column headed 7 in the mapping data object. The mapping data column labeled 7 contains the word Financial.

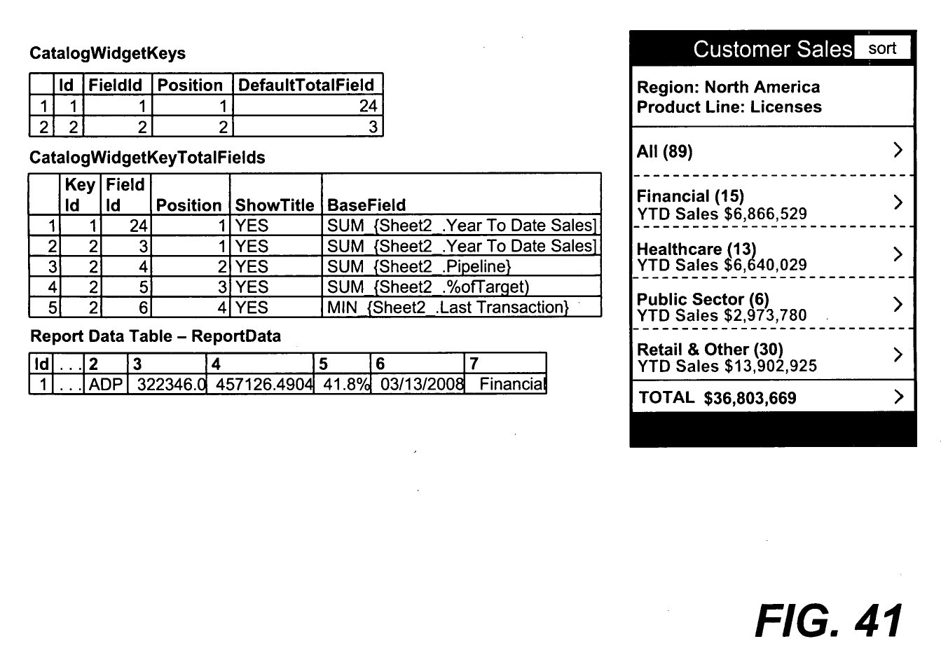

FIG. 41 is an illustrative drawing showing relationships among the CatalogWidgetKeys object, the CatalogWidgetKeyTotalFields object and the mapping data object and structure of a first screen display in accordance with some embodiments of the invention. The first row of the CatalogWidgetKeys object indicates that Id 1 corresponds to FieldId 1 and Position 1. The CatalogWidgetKeyTotalFields object indicates that the KeyId 1 corresponds to FieldId 24. Accordingly, each first subject identifier (e.g., each Business Unit in this example) is associated in the illustrative first screen display first with a first subject item data from column 24 of the mapping data object. The relationships described with reference to FIG. 41 are consistent with those described with reference to FIG. 35, since the value 24 is contained within both the DefaultTotalfield of the CatalogWidgetKeys object and the FieldId of the CatalogWidgetKeyTotalFields object.

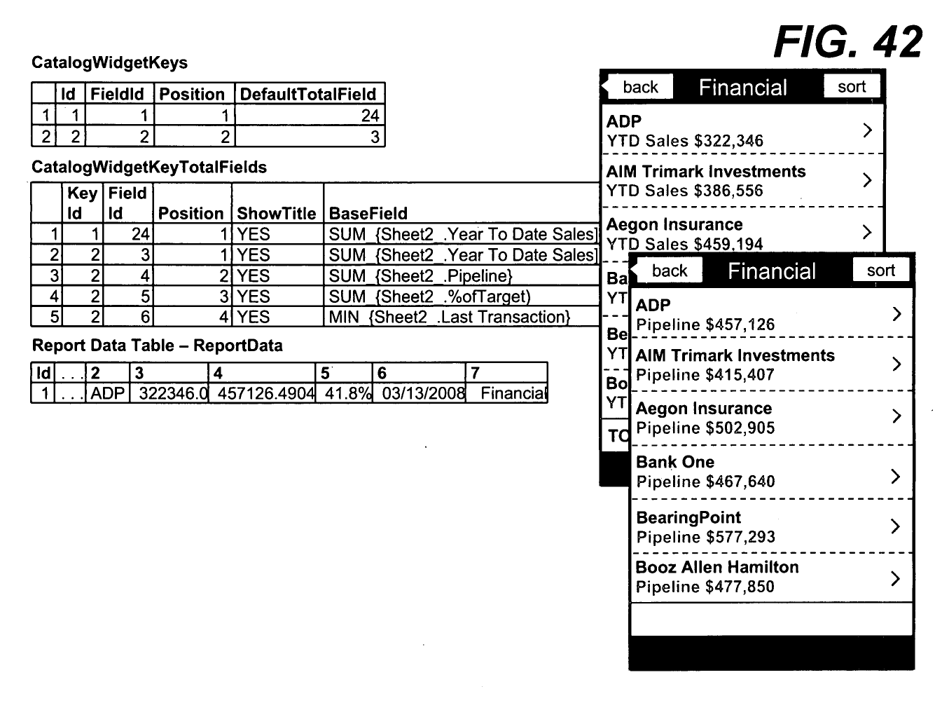

FIG. 42 is an illustrative drawing showing relationships among the CatalogWidgetKeys object, the CatalogWidgetKeyTotalFields object and the mapping data object and two different illustrative second screen displays in accordance with some embodiments of the invention. In particular, FIG. 42 illustrates different associations of second subject data items with second subject identifiers. In some embodiments, a user can scroll horizontally through a second sequence of second screen displays in which each second screen display in such second sequence includes the same second subject identifiers and in which different second screen displays in such second sequence display such second subject identifiers associated with different second subject data items. Each different association between the second subject identifiers and second subject data items corresponds to a different column of the mapping data object.

More specifically, as indicated by the second row of the CatalogWidgetKeyTotalFields object, when a user selects a first subject identifier from a first screen display (not shown), a corresponding second screen display is displayed on the device screen display. For example, assuming that a user selects the first subject identifier labeled, Financial YTD Sales from the first screen display shown in FIG. 41, then in response the second screen display shown in the background in FIG. 42 is displayed, in which the second subject identifiers are Clients within the Financial Business Unit and in which the associated second subject data items comprise individual Client YTD Sales.

Where Key Id in CatalogWidgetKeyTotalFields equals 2, these rows relate to the second subject identifiers. Here, FieldIds 3, 4, 5, and 6 all are associated with KeyId equals 2. Thus,a user can scroll horizontally between the report data of 3, 4, 5, and 6. These FieldId references are converted to data from the ReportDataTable by looking them up in that ReportData object. The starting point is Field Id 3, (corresponding to a ReportDataTaable value 322346.0 in this example), which is shown in FIG. 35 on the first line of the screen display shown in the background. Then if the user were to input a horizontal scroll movement from left to right, the display would show a ReportDataTable value corresponding to FieldId 4, in this example, Pipeline at value 457126.4904. This value is shown in FIG. 35 on the first line of the screen display shown in the foreground screen.

Referring to the two second screen displays shown on the right in FIG. 42, in response to user inputs a command to scroll horizontally from one second screen display to a next in the second sequence, the device transitions between the second screen display in the background and that in the foreground. If while, the device display screen portrays the second screen display in the background containing second subject data items that represent YTD Sales, which corresponds to the column headed 3 (Report Data) in the mapping data object, and the user enters a command to horizontally scroll to a next second screen display in the second sequence of displays, then the device transitions to the screen display screen display shown in the foreground that includes second subject data items that represent sales in the Pipeline, which corresponds to the column headed 4 (Report Data).

In some embodiments, for example, a user may input a user interface command to transition between different screen displays within a sequence of screen displays by swiping across the display screen. A swiping action across the screen in one direction effects a command to transition in one direction within the data, and a swipe across the screen in an opposite direction may affect a command to transition in an opposite direction within the data. For instance, assuming that the screen currently shows the background second screen display shown in FIG. 42, then a user swipe from right to left causes the screen display to transition to the foreground second screen display shown in FIG. 42. Conversely, assuming that the screen currently shows the foreground second screen display shown in FIG. 42, then a user swipe from left to right causes the screen display to transition to the background second screen display shown in FIG. 42.

User Interface Process to Navigate Screen Displays Using Metadata Structures

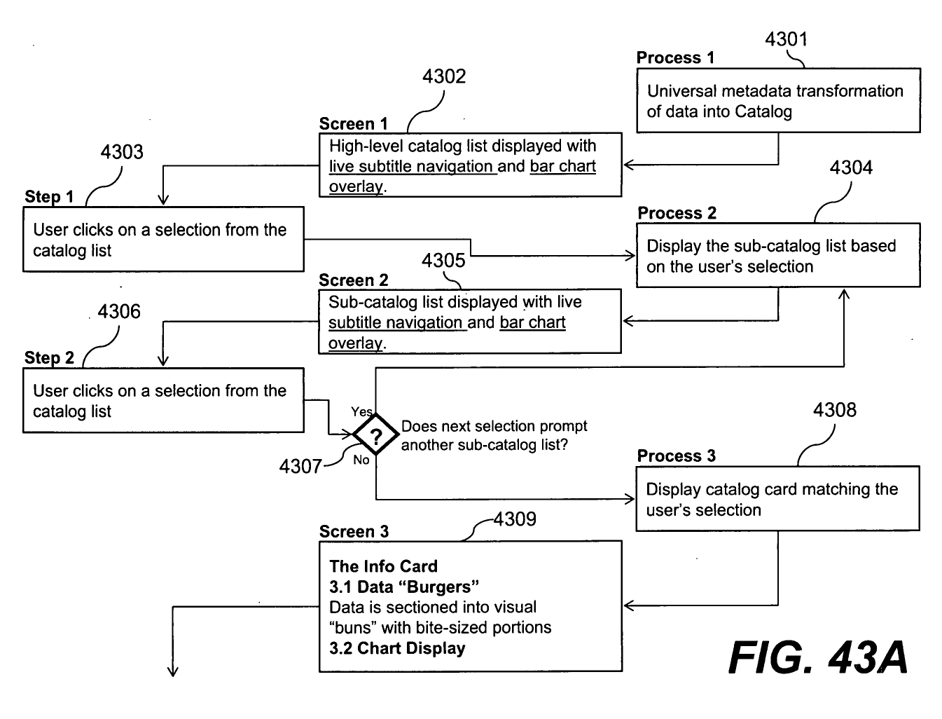

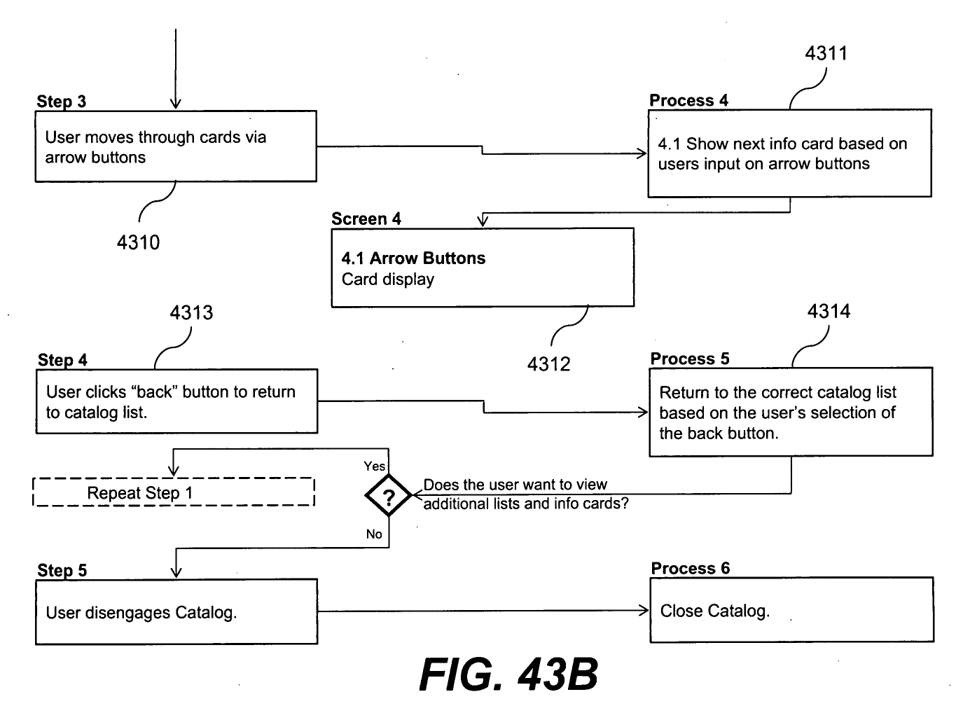

FIGS. 43A-43B show illustrative flow diagrams representing a computer program controlled process responsive to user input commands to cause an electronic device to respond to user input to produce the screen displays described with reference to FIGS. 3-16 using the structural information provided in the data objects and metadata described with reference to FIGS. 18-41 in accordance with some embodiments of the invention. The process may be implemented using computer program instructions encoded in a computer readable medium and executed by the device. Process block 4301 represents a process that encompasses the process of FIG. 18, in which the device uses CatalogWidgetKeys object and the mapping data object in a manner generally similar to that described with reference to FIG. 36 to produce a screen display from the first sequence of screen displays. Screen block 4302 represents the device displaying one of the first level screen displays from the first sequence of screen displays in response to the process of block 4301. User input process block 4303 represents a user input process in which a user inputs to the device a command indicating selection of a first level subject identifier from within the first screen display represented by screen block 4302. The user input process of block 4303 can employ any of a variety of different user input techniques including pointing a cursor and clicking or tapping on the selected identifier option or swiping a finger across the screen or choosing a pull-down menu or actuating a control button to name a few, for example.

The user input represented by user input block 4303 causes the device to execute a process represented by process block 4304 in which the device uses metadata and mapping data to produce a screen display from a next level down, in the screen display hierarchy, from a screen display in which the user provided input in user input block 4303. In the embodiment described herein, the next level down comprises the second level screen displays, and the process block 4304 uses the CatalogWidgetKeys object and the mapping data object in a manner generally similar to that described with reference to FIG. 38 to produce a screen display from the second sequence of screen displays. Screen block 4305 represents the device displaying one of the second screen displays from the second sequence of screen displays in response to the process of process block 4304. User input process block 4306 represents a process to receive a user input in which a user inputs a command indicating selection of a subject identifier from within the second screen display represented by screen block 4305.

Decision block 4307 determines whether the current level is the lowest level in the hierarchy of subject identifiers. In the embodiment described herein, there are only two levels of hierarchy, Business Units (first level subject identifiers) and Clients (second level subject identifiers). Clients are a sub-category of Business units in the source data object. Accordingly Clients correspond to second level subject identifiers, and Business Units correspond to first level subject identifiers in some embodiments of the invention. However in other embodiments (not shown) there may be more than two sub-categories in the source data object. For example, there might be a sub-category of Clients, such as Client Business Units (not shown), resulting in a third level of subject identifiers (not shown).

If the decision process 4307 determines that a current level is not the lowest level in the hierarchy of subject identifiers, then control flows back to process block 4304, in which the device once again uses the metadata and mapping data to produce a screen display from a next level down, in the screen display hierarchy. The loop involving process block 4304, screen block 4305 and user input block 4306 repeats until a user input causes the device to display a lowest level screen display in the hierarchy. As mentioned above, the embodiment described in detail herein has only two levels and the second level one is the lowest level in the screen display hierarchy.

If on the other hand, the decision process 4307 determines that a current level is the lowest level in the hierarchy of subject identifiers, then control flows to process block 4308, in which the device once again uses the metadata and mapping data to produce a screen display at the lowest level of the subject identifier hierarchy. In the embodiment described in detail herein, the second level is the lowest level of the hierarchy, and the process block 4308 uses the CatalogWidget Keys object, the CatalogWidgetGroups object, the CatalogWidgetGroupFields object, and the mapping data object in a manner generally similar to that described with reference to FIGS. 39-40 to produce a third screen display that shows multiple second level data items corresponding to a user-selected second level subject identifier within the current second level screen display. Screen block 4309 represents the device displaying one of the third screen displays in response to the process of process block 4308.

User input process block 4310 responds to user input in which a user inputs a command indicating selection of a different third screen corresponding to a different second subject identifier. In the embodiment described in detail herein, user input involves selecting up/down buttons such as those shown in FIGS. 39-40. In the embodiment described herein, process block 4311 uses the CatalogWidget Keys object, the CatalogWidgetGroups object, the CatalogWidgetGroupFields object, and the mapping data object in a manner generally similar to that described with reference to FIGS. 39-40 to scroll vertically through different groupings of second level data items corresponding to different second level subject identifiers in response to user actuation of the up/down buttons. Screen display block 4312 displays the different second subject level identifiers and different groups of second subject level data items in response to process block 4311. That is, a user scrolls through different cards using the up/down buttons.

User input process block 4313 responds to user input in which a user inputs a command indicating selection of a screen display of a next higher up level in the subject hierarchy. Process block 4314 causes the device to produce a display screen from a next level up in the hierarchy in response to user input received in user input block 4313. Referring to FIGS. 38-39, for example, a user selection of the ‘back’ button in the third screen display of FIG. 39 causes process block 4314 to causes the device to display the second level screen display of FIG. 39. Similarly, referring to FIGS. 36 and 38, for example, a user selection of the ‘back’ button in the second subject level screen display of FIG. 38 causes process block 4314 to causes the device to display the first subject level screen display of FIG. 36. Thus, users can back-track through a subject level hierarchy through actuation of the ‘back’ button. As a user causes the screen display to back-track, control shifts to the process block or decision block corresponding to the next subject level up in the hierarchy. For example, if actuating the ‘back’ button leads back to the second subject level, then control flow moves to process block 4314.

### Process for Dynamic Placement and Sizing of Bar Charts

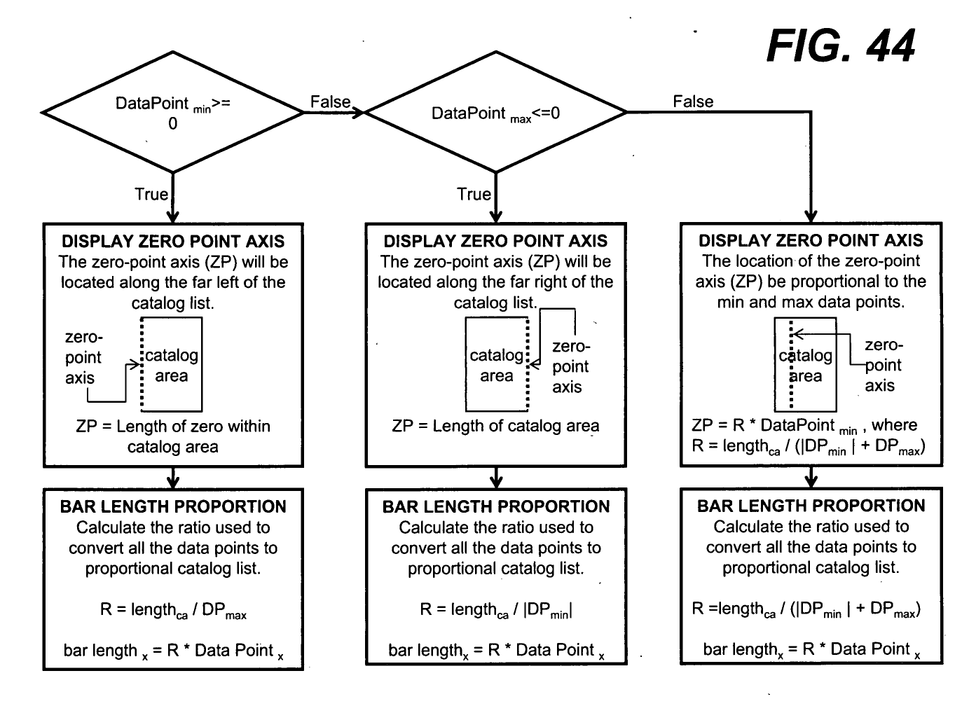

FIG. 44 is an illustrative flow diagram representing a process of dynamic placement and sizing of bar chart bars in accordance with some embodiments of the invention. The dynamic placement and sizing process can be implemented using computer readable instructions encoded in computer readable media that control the display the bar chart by the device. FIG. 10 shows an illustrative example of a bar chart overlay in a screen display.

In the flow diagram of FIG. 44, it is assumed that the following values are known.

TABLE
Known Values

| Value Name | Definition | Comment |
|---|---|---|
| Bar width | The width of the each bar | The bar width is defined as |
| | overlay | the text area of the value |
| | | listed on the catalog list |
| | | plus 2 pixels above and |
| | | below the text value. |
| Lengthca | Length of the catalog area | The length of the catalog |
| | | area is determined by the |
| | | dimensions of the display |
| | | screen less any predefined |
| | | margins |
| DataPoint min | The smallest numerical | |
| | value in the data set | |
| DataPoint min | The smallest numerical | |
| | value in the data set | |
| DataPoint max | The largest numerical value | |
| | in the data set | |

In the flow diagram of FIG. 44, it is assumed that the following values are derived.

TABLE
Derived Values

| Value Name | Definition | Comment |
|---|---|---|
| ZP | Traditionally, this axis is | |
| | called the x-axis, but | |
| | because of the rotating | |
| | capabilities of the iPhone, | |
| | we will call this the Zero | |
| | Point axis (ZP). | |
| R | The ratio to convert the data | |
| | point to the correct scale of | |
| | the chart. | |
| Bar lengthx | The length across the screen | |
| | each bar extends. | |

The bar chart overlay is computed dynamically relative to the data point values. As shown and explained in FIG. 44, the placement of the zero axis within a display screen is computed using the values above based upon whether a minimum data point value is greater than zero or a maximum data point is less than zero, or if neither of those situations hold, and the bar chart lengths are proportioned based upon the values above in combination with minimum or maximum data point values or some combination thereof.

### Device with Display Screen

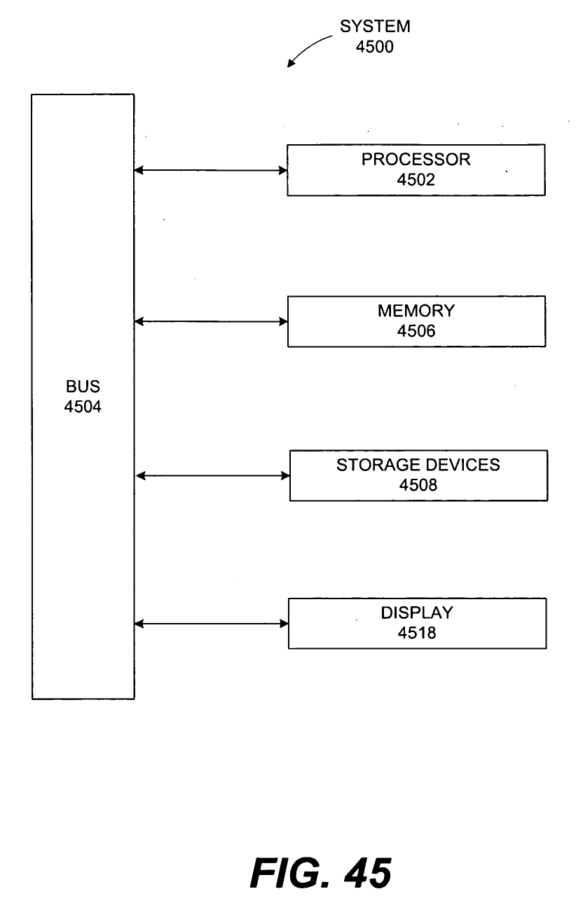

FIG. 45 is an illustrative block level diagram of a processing device 4500 that can be programmed to implement processes involved navigating information from a tabular document having multiple levels of subject identifiers and corresponding data items in accordance with embodiments of the invention. Device 4500 may be embodied in any number of different devices such as a personal computer, object computer, smart mobile device or mobile phone, for example. Processing device 4500 can include one or more processors, such as a processor 4502. Device 4500 can be implemented using a general or special purpose processing engine such as, for example, a microprocessor, controller or other control logic. In the example illustrated in FIG. 45, processor 4502 is connected to a communication channel, i.e., bus 4504 or other communication medium.

Device 4500 also can include a main memory 4506, preferably random access memory (RAM) or other dynamic memory, for storing information and instructions to be executed by processor 4502. Main memory 4506 also may be used for storing temporary variables or other intermediate information during execution of instructions to be executed by processor 4502. Device 4500 can likewise include a additional storage devices such as read only memory (“ROM”), a hard disk, a floppy disk, magnetic tape, optical disk, a CD or DVD, Flash storage or other fixed or removable medium to store static information and instructions for processor 4502. The main memory 4506 and the storage devices 4508 may store data such as a document including document source information, for example. The main memory 4506 and the storage devices 4508 may store metadata and mapping information and instructions such as instructions for the program controlled processes of FIGS. 43A-43B. The main memory 4506 and the storage devices 4508 also may store instructions to generate the display of the first and second sequences of screen display and the multiple third screen displays described herein. The processing system 4500 also includes a display screen 4518 used to display the first and second sequences of screen display and the multiple third screen displays in response to such instructions.

In this specification, the term “computer readable storage medium” is used to generally refer to media such as, for example, memory 4506, storage device 4508, a hard disk installed in hard disk drive 4510. These and other various forms of computer useable storage media may be involved in carrying one or more sequences of one or more instructions to processor 4502 for execution. Such instructions, generally referred to as “computer program code” (which may be grouped in the form of computer programs or other groupings), when executed, enable the device 4500 to perform features or functions of the present invention as discussed herein.

The foregoing description and drawings of preferred embodiments in accordance with the present invention are merely illustrative of the principles of the invention. Various modifications can be made to the embodiments by those skilled in the art without departing from the spirit and scope of the invention, which is defined in the appended claims.

1. A method to display information on a display screen of an electronic device comprising:
providing subject identifiers in computer readable storage media;
providing subject data items in multiple categories in the media;
providing indicia in the media of respective associations between respective subject identifiers and respective subject data items from respective ones of the multiple categories;
producing a plurality of screen displays;
wherein different screen displays include the plurality of the subject identifiers and respective associated subject data items from different respective ones of the multiple categories.

2. The method of claim 1 further including:
providing indicia in the media of ordering among the multiple categories; and
producing the plurality of screen displays in a sequence order;
wherein the sequence order matches the indicia of ordering among the categories of data items that are included in the plurality of screen displays.

3. The method of claim 2, wherein producing the plurality of screen displays includes:
producing a given screen display from the plurality of screen displays that includes a plurality of the subject identifiers and respective associated subject data items from a respective given category;
receiving an input command to display a different screen display;.
in response to the input command, obtaining from the media respective subject data items associated with a next category relative to the given category in the ordering; and
producing a next screen display in the sequence order that includes the obtained respective subject data items.

4. The method of claim 3,
wherein the input command indicates direction relative to the sequence order; and
wherein obtaining from the media includes obtaining respective subject data items associated with a next category relative to the direction indicated by the input command.

5. The method of claim 1 further including:
producing a given screen display from the plurality of screen displays that includes a plurality of the subject identifiers and respective associated subject data items from a respective given category; and
scrolling the given screen display vertically to change the subject identifiers and associated subject data items that are in view on the screen display.

6. The method of claim 1 further including:
wherein producing the plurality of screen displays includes:
producing a given screen display from the plurality of screen displays that includes a plurality of the subject identifiers and respective associated subject data items from a respective given category;
receiving an input command to display a different screen display;
in response to the input command, obtaining from the media respective subject data items associated with a different category from the given category; and
prior to receiving the input command, automatically shifting at least one screen display across the display screen;

7. A method to display information on a display screen of an electronic device comprising:
providing first subject identifiers in computer readable storage media;
providing first subject data items in the media;
providing indicia in the media of respective associations between first subject identifiers and respective first subject data items;
providing multiple sets of second subject identifiers in the media;
providing second subject data items in multiple categories in the media;
providing indicia in the media of respective associations between respective second subject identifiers and respective second subject data items from different respective ones of the multiple categories;
providing indicia in the media of respective associations between respective first subject identifiers and respective sets of second subject identifiers;
producing a first screen display;
wherein the first screen display includes a plurality of the first subject identifiers and respective associated first subject data items;
producing a plurality of sequences of second screen displays;
wherein for each respective sequence of second screen displays, different second screen displays in such sequence of second screen displays include a respective set of second subject identifiers associated with a respective first subject identifier and include different respective associated second subject data items from different ones of the multiple categories.

8. The method of claim 7 further including:
providing indicia in the media of ordering among the multiple categories;
wherein producing the plurality of second screen displays includes producing the second plurality of second screen displays in a second sequence order; and
wherein the second sequence order matches the indicia of ordering among the categories of second data items that are included in the respective sequence of second screen displays.

9. The method of claim 7 further including:
while producing the first screen display that includes a plurality of the first subject identifiers, receiving an input command to change screen display levels;
wherein the input command to change screen display levels includes a selection of a given first subject identifier included in the first screen display;
in response to the input command to change screen display levels, obtaining from the media a respective set of second subject identifiers associated with the selected first subject identifier and obtaining second subject data items associated with the second subject identifiers of such obtained set; and
producing a second screen display that includes the set of second subject identifiers and the associated second subject data items obtained from the media in response to the input command to change screen display levels.

10. The method of claim 8,
wherein producing the second plurality of first screen displays includes:
producing a second screen display from a given one of the set of second screen displays that includes the second list of respective second subject identifiers and respective associated second subject data items from a respective given associated category;
receiving a second input command to change to a different screen display within the given set of second screen displays;
in response to the second input command, obtaining from the media respective second subject data items associated with the same respective second subject identifiers and associated with a next category relative to the given category in the ordering; and
producing a different second screen display from the given set that includes the same second list of respective second subject identifiers and that includes the respective associated second subject data items obtained from the media in response to the second input command.

11. The method of claim 10,
wherein the second input command includes indicia of direction relative to the ordering of categories; and
wherein obtaining from the media in response to the second input command includes obtaining respective second subject data items associated with a next category relative to the given category direction indicated in the second input command.

12. A method to display information on a display screen of an electronic device comprising:
providing first subject identifiers in computer readable storage media;
providing first subject data items in multiple categories in the media;
providing indicia in the media of respective associations between respective first subject identifiers and respective first subject data items from different respective ones of the multiple categories;
providing a multiple sets of second subject identifiers in the media;
providing second subject data items in multiple categories in the media;
providing indicia in the media of respective associations between respective second subject identifiers and respective second subject data items from different respective ones of the multiple categories;
providing indicia in the media of respective associations between respective first subject identifiers and respective sets of second subject identifiers;
producing a first plurality of first screen displays;
wherein different first screen displays include the first subject identifiers and respective associated respective first subject data items from different respective ones of the multiple categories;
producing a plurality of second screen displays
wherein respective different ones of the second plurality of second screen displays includes a respective set of second subject identifiers associated with different ones of the respective first subject identifiers and includes respective associated second subject data items from different respective ones of the multiple categories.

13. The method of claim 12 further including:
providing indicia in the media of ordering among the multiple categories;
wherein producing the first plurality of first screen displays includes producing the first plurality of first screen displays in a first sequence order;
wherein the first sequence order matches the indicia of ordering among the categories of first data items that are included in the first plurality of screen displays;
wherein producing the plurality of second screen displays includes producing the second plurality of second screen displays in a second sequence order; and
wherein the second sequence order matches the indicia of ordering among the categories of second data items that are included in the respective sequence of second screen displays.

14. The method of claim 12 further including:
while producing a given first screen display that includes a plurality of the first subject identifiers and respective associated first subject data items from a given category, receiving an input command to change screen display levels;
wherein the input command to change screen display levels includes a selection of a given first subject identifier included in the given first screen display;
in response to the input command to change screen display levels, obtaining from the media a respective set of second subject identifiers associated with the selected first subject identifier and obtaining second subject data items from the given category that are respectively associated with the second subject identifiers of such obtained set; and
producing a second screen display that includes the set of second subject identifiers and the associated second subject data items from the given category obtained from the media in response to the input command to change screen display levels.

15. The method of claim 13,
wherein producing the first plurality of first screen displays includes:
producing a given screen display from the first plurality of screen displays that includes a plurality of the first subject identifiers and respective associated first subject data items from a respective given category;
receiving a first input command to display a different first screen display;.
in response to the first input command, obtaining from the media respective first subject data items associated with a next category relative to the given category in the ordering; and
producing a next screen first screen display in the sequence order that includes the obtained respective first subject data items; and
wherein producing the second plurality of first screen displays includes:
producing a second screen display from a given one of the set of second screen displays that includes the second list of respective second subject identifiers and respective associated second subject data items from a respective given associated category;
receiving a second input command to change to a different screen display within the given set of second screen displays;
in response to the second input command, obtaining from the media respective second subject data items associated with the same respective second subject identifiers and associated with a next category relative to the given category in the ordering; and
producing a different second screen display from the given set that includes the same second list of respective second subject identifiers and that includes the respective associated second subject data items obtained from the media in response to the second input command.

16. The method of claim 15,
wherein the first input command indicates direction relative to the sequence order;
wherein obtaining from the media includes obtaining respective subject data items associated with a next category relative to the direction indicated by the first input command;
wherein the second input command indicates direction relative to the sequence order;
wherein obtaining from the media includes obtaining respective subject data items associated with a next category relative to the direction indicated by the second input command.

17. A method to display information on a display screen of an electronic device comprising:
providing second subject identifiers in computer readable storage media;
providing second subject data items in multiple categories in the media;
providing indicia in the media of respective associations between respective second subject identifiers and respective second subject data items from different respective ones of the multiple categories;
producing a second plurality of second screen displays;
wherein different second screen displays include the second subject identifiers and respective associated respective second subject data items from different respective ones of the multiple categories;
while producing the second screen display that includes the second subject identifiers, receiving an input command to change screen display level;
wherein the second input command to change screen display level includes a selection of a second subject identifier included in the second screen display produced while the second command to change screen display levels is received;
in response to the second input command to change screen display levels, obtaining from the media multiple different second subject data items that are each associated with the selected second subject identifier and that are respectively associated with multiple different categories; and
producing a third screen display that includes the selected second subject identifier and the multiple different second subject data items obtained from the media in response to the second input command to change screen display levels.

18. The method of claim 17 further including:
providing indicia in the media of ordering among the multiple categories;
wherein producing the plurality of second screen displays includes producing the second plurality of second screen displays in a second sequence order; and
wherein the second sequence order matches the indicia of ordering among the categories of second data items that are included in the respective sequence of second screen displays.

19. The method of claim 18,
wherein the second input command indicates direction relative to the sequence order;
wherein obtaining from the media includes obtaining respective subject data items associated with a next category relative to the direction indicated by the second input command.

20. A method to display information on a display screen of an electronic device comprising:
providing first subject identifiers in computer readable storage media;
providing first subject data items in the media;
providing indicia in the media of respective associations between first subject identifiers and respective first subject data items;
providing multiple sets of second subject identifiers in the media;
providing second subject data items in multiple categories in the media;
providing indicia in the media of respective associations between respective second subject identifiers and respective second subject data items from different respective ones of the multiple categories;
providing indicia in the media of respective associations between respective first subject identifiers and respective sets of second subject identifiers;
producing a first screen display;
wherein the first screen display includes a plurality of the first subject identifiers and respective associated first subject data items;
producing a plurality of sequences of second screen displays;
wherein for each respective sequence of second screen displays, different second screen displays in such sequence of second screen displays include a respective set of second subject identifiers associated with a respective first subject identifier and include respective associated second subject data items from different respective ones of the multiple categories;
while producing the second screen display that includes the second subject identifiers, receiving an input command to change screen display level;.
wherein the second input command to change screen display level includes a selection of a second subject identifier included in the second screen display produced while the second command to change screen display levels is received;
in response to the second input command to change screen display levels, obtaining from the media multiple respective second subject data items that are each associated with the selected second subject identifier and that are respectively associated with multiple respective categories; and
producing a third screen display that includes the selected second subject identifier and the multiple respective second subject data items obtained from the media in response to the second input command to change screen display levels.

21. The method of claim 20 further including:
providing indicia in the media of ordering among the multiple categories;
wherein producing the first plurality of first screen displays includes producing the first plurality of first screen displays in a first sequence order;
wherein the first sequence order matches the indicia of ordering among the categories of first data items that are included in the first plurality of screen displays;
wherein producing the plurality of second screen displays includes producing the second plurality of second screen displays in a second sequence order; and
wherein the second sequence order matches the indicia of ordering among the categories of second data items that are included in the respective sequence of second screen displays.

22. The method of claim 20 further including:
while producing the first screen display that includes a plurality of the first subject identifiers, receiving an input command to change screen display levels;
wherein the input command to change screen display levels includes a selection of a given first subject identifier included in the first screen display;
in response to the input command to change screen display levels, obtaining from the media a respective set of second subject identifiers associated with the selected first subject identifier and obtaining second subject data items associated with the second subject identifiers of such obtained set; and
producing a second screen display that includes the set of second subject identifiers and the associated second subject data items obtained from the media in response to the input command to change screen display levels.

23. The method of claim 21 further including:
producing a second screen display from a given one of the set of second screen displays that includes the second list of respective second subject identifiers and respective associated second subject data items from a respective given associated category;
receiving a second input command to change to a different screen display within the given set of second screen displays;
in response to the second input command, obtaining from the media respective second subject data items associated with the same respective second subject identifiers and associated with a next category relative to the given category in the ordering; and
producing a different second screen display from the given set that includes the same second list of respective second subject identifiers and that includes the respective associated second subject data items obtained from the media in response to the second input command.

24. The method of claim 23,
wherein the second input command includes indicia of direction relative to the ordering of categories; and
wherein obtaining from the media in response to the second input command includes obtaining respective second subject data items associated with a next category relative to the given category direction indicated in the second input command.

25. A method to display information on a display screen of an electronic device comprising:
providing subject identifiers in computer readable storage media;
providing subject data items in multiple categories in the media;
providing indicia in the media of respective associations between respective subject identifiers and respective subject data items from different respective ones of the multiple categories;
producing a screen display that includes a plurality of the subject identifiers and that includes respective associated subject data items from a given category;
receiving a input command to change screen display;
in response to the input command, obtaining from the media respective subject data items associated the same respective subject identifiers and from a different category; and
producing a screen display that includes the same subject identifiers and that includes the respective associated subject data items from the different category obtained from the media in response to the input command.

26. A method to display information on a display screen of an electronic device comprising:
providing multiple respective subject identifiers in computer readable storage media;
providing a plurality of respective subject data items in multiple categories in the media;
providing indicia in the media of respective associations between respective subject identifiers and respective subject data items from different respective ones of the multiple categories;
providing indicia in the media of respective group associations between different respective categories so as to define multiple groupings of categories; and
producing a third screen display that includes a respective subject identifier and multiple subject data items that are associated with the respective subject identifier and that shows the displayed multiple subject data items grouped by category as defined in the multiple groupings.

27. The method of claim 26 further including:
scrolling the third screen display vertically to change the subject data items that are in view on the screen display.

28. The method of claim 26 further including:
receiving an input command to display a different third screen display;
in response to the input command, obtaining from the media multiple respective different second subject data items associated with a different respective subject identifier; and
producing a different third screen display that includes the respective different subject data item and the different multiple second subject data items and that shows the different multiple second subject data items grouped by category as defined in the multiple groupings.

29. A method to display information on a display screen of an electronic device comprising:
providing first through Nth sets of subject identifiers in computer readable storage media;
providing first through Nth sets of subject data items in multiple categories in the media;
providing indicia in the media of respective associations between respective subject identifiers of the ith set of subject identifiers and respective subject data items of the ith set of subject data items for each i;
wherein providing indicia in the media of respective associations between a respective i−1 subject identifier and respective sets of ith second subject identifiers for each i;
producing a plurality of sequences of ith screen displays for multiple values of i;
wherein for each respective ith screen display sequence, different ith screen displays in such ith sequence of ith screen displays includes a respective set of ith subject identifiers associated with a respective i−1 subject identifier and includes different respective associated ith subject data items from different ones of the multiple categories.

30. The method of claim 29 further including:
providing indicia in the media of respective group associations between different respective categories so as to define multiple groupings of categories; and
producing a screen display that includes a respective ith subject identifier and ith subject data items that are associated with the respective ith subject identifier and that are from different categories;
wherein the screen display shows the associated ith multiple categories of the selected subject data item grouped by category as defined in the multiple groupings.

31. A method to display information on a display screen of an electronic device comprising:
providing subject identifiers in computer readable storage media;
providing subject data items in multiple categories in the media;
providing indicia in the media of respective associations between respective subject identifiers and respective subject data items from respective ones of the multiple categories;
producing a plurality of screen displays;
wherein different screen displays include respective subject data items that are associated with a respective subject identifier and that are from different respective ones of the multiple categories.

32. The method of claim 31,
wherein different screen displays also include the plurality of the subject identifiers associated with the respective displayed subject data items.

33. An article of manufacture including computer readable storage media encoded with computer readable information comprising:
a data structure,
providing subject identifiers;
providing subject data items in multiple categories;
providing indicia of respective associations between respective subject identifiers and respective subject data items from different respective ones of the multiple categories;
computer program code to cause the device to perform a process comprising,
producing a plurality of screen displays;
wherein different screen displays include a plurality of the subject identifiers and respective associated subject data items from different respective ones of the multiple categories.

34. The article of manufacture of claim 33, wherein the data structure includes a plurality of objects.

35. The article of manufacture of claim 33,
wherein the data structure includes structure,
providing indicia in the media of ordering among the multiple categories; and
wherein the computer program code causes the device to perform a process that further comprises,
producing the plurality of screen displays in a sequence order;
wherein the sequence order matches the indicia of ordering among the categories of data items that are included in the plurality of screen displays.

36. The method of claim 34 wherein the plurality of objects include a plurality of tables.

37. An electronic device comprising:
a processor;
storage media to store processor readable information; and
a communication bus coupling the processor and the storage media;
wherein the storage media is encoded with computer readable information comprising:
a data structure,
providing subject identifiers;
providing subject data items in multiple categories;
providing indicia of respective associations between respective subject identifiers and respective subject data items from different respective ones of the multiple categories;
computer program code to cause the device to perform a process comprising,
producing a plurality of screen displays;
wherein different screen displays include a plurality of the subject identifiers and respective associated subject data items from different respective ones of the multiple categories.

38. The system of manufacture of claim 37, wherein the data structure includes a plurality of objects.

39. The system of claim 37,
wherein the data structure includes structure,
providing indicia in the media of ordering among the multiple categories; and
wherein the computer program code causes the device to perform a process that further comprises,
producing the plurality of screen displays in a sequence order;
wherein the sequence order matches the indicia of ordering among the categories of data items that are included in the plurality of screen displays.
